(19) United States
(12) Patent Application Publication
(10) Pub. No.: US 2020/0360851 A1
(43) Pub. Date: Nov. 19, 2020

(54) SPRAYED COATED AND MOLDED POLYMERIC LAYER WRAPPINGS FOR FILTER MEDIA

(71) Applicant: Cummins Filtration IP, Inc., Columbus, IN (US)

(72) Inventors: Scott W. Schwartz, Cottage Grove, WI (US); Mark V. Holzmann, Stoughton, WI (US); John W. Wacker, Evansville, WI (US); Jamie M. Zenger, Cottage Grove, WI (US)

(73) Assignee: Cummins Filtration IP, Inc., Columbus, IN (US)

(21) Appl. No.: 16/967,211

(22) PCT Filed: Feb. 12, 2018
(86) PCT No.: PCT/US2018/017823

§ 371 Date: Aug. 4, 2020

(51) Int. Cl. B01D 46/52; B01D 46/00

(52) U.S. Cl. CPC B01D 46/521; B01D 46/10; B01D 46/0005

(57) ABSTRACT

A method of forming a filter element having at least a portion of a filter media thereof encased in a polymeric layer comprises providing a filter media, and providing abase layer. A polymeric layer is deposited on the base layer so as to form a wrapping layer. A face of the filter media is positioned on the polymeric layer within a predetermined time. The wrapping layer is wrapped around at least a portion of the filter media. Another method of forming a filter element having at least a portion of a filter media thereof encased in a polymeric layer comprises providing a filter media. A polymeric layer is spray deposited in a mold cavity of a mold. A first face of the filter media is positioned on the polymeric layer within a predetermined time. The filter media is removed from the mold cavity with the polymeric layer attached thereto.

### TECHNICAL FIELD

The present disclosure relates generally to filters for use with internal combustion engine systems.

### BACKGROUND

Internal combustion engines generally use various fluids during operation. For example, fuel (e.g., diesel, gasoline, natural gas, etc.) is used to run the engine. Air may be mixed with the fuel to produce an air-fuel mixture, which is then used by the engine to run under stoichiometric or lean conditions. Furthermore, one or more lubricants may be provided to the engine to lubricate various parts of the engine (e.g., piston cylinder, crank shaft, bearings, gears, valves, cams, etc.). These fluids may become contaminated with particulate matter (e.g., carbon, dust, metal particles, etc.) which may damage the various parts of the engine if not removed from the fluid.

Some conventional filter elements include a filter media such as a pleated filter media, or a filter media including a stack of filter media layers (e.g., corrugated filter media layers). Such filter elements may be wrapped in wrapping layer, for example a cardboard layer so as to secure the filter media (e.g., to maintain a position of the pleats of the filter media) or prevent the filter media layers in the stack from being separated from each other. Such wrapping layers may be aesthetically pleasing and are may be suitable for printing markings (e.g., company name and logo) thereon. However, such wrapping layers are susceptible to mechanical damage, for example, tearing or puncturing during handling or installation which may cause damage to the filter media positioned therewithin.

### SUMMARY

Embodiments described herein relate generally to systems and methods for encapsulating at least a portion of a filter media in a polymeric layer. In particular, systems and methods described herein provide for depositing polymeric layer on a base layer to form wrapping layer, and wrapping the wrapping layer around the filter media, or depositing a polymeric layer in a mold cavity of a mold and embedding the filter media in the polymeric layer deposited in the mold cavity.

In a first set of embodiments, a method of forming a filter element having at least a portion of a filter media thereof encased in a polymeric layer comprises providing the filter media. A base layer is provided. The polymeric layer is deposited on the base layer so as to form a wrapping layer. A face of the filter media is positioned on the polymeric layer within a predetermined time. The wrapping layer is wrapped around at least a portion of the filter media.

In another set of embodiments, a method of forming a filter element having at least a portion of a filter media thereof encased in a polymeric layer comprises providing the filter media. A polymeric layer is spray deposited in a mold cavity of a mold. A first face of the filter media is positioned on the polymeric layer within a predetermined time. The filter media is removed with the polymeric layer attached to the first face thereof from the mold cavity. The removing causes the polymeric layer to be removed from the mold cavity along with the filter media.

In yet another set of embodiments, a method of forming a filter element having at least a portion of a filter media thereof encased in a polymeric layer comprises providing the filter media. A first polymeric layer is deposited in a mold cavity of a mold. A first face of the filter media is positioned on the first polymeric layer within a predetermined time. The filter media is removed from the mold cavity with the first polymeric layer attached to the first face thereof, the removing causing the first polymeric layer to be removed from the mold cavity along with the filter media. A second polymeric layer is deposited in a seal mold cavity of a seal mold. The first face of the filter media is positioned on the second polymeric layer within a second predetermined time so as to seal the first face. The filter media is removed from the seal mold cavity with the second polymeric layer attached to the first face.

In still another set of embodiments, a method of forming a filter element having at least a portion of a filter media thereof encased in a polymeric layer comprises providing a filter media. A first face label is positioned in a mold cavity of a mold such that a front surface of the first face label is positioned on a base of the mold cavity. A polymeric layer is deposited in the mold cavity on a back surface of the first face label. A first face of the filter media is positioned on the polymeric layer within a predetermined time. The filter media is removed from the mold cavity with the polymeric layer attached to the first face of the filter media, and the back surface of the first face label attached to the polymeric layer from the mold cavity, the removing causing the first polymeric layer and the first face label to be removed from the mold cavity along with the filter media.

In yet another set of embodiments, a method of forming a filter element having at least a portion of a filter media thereof encased in a polymeric layer comprises providing a filter media. A first face label is positioned in a mold cavity first portion of a mold such that a front surface of the first face label is positioned on a base of the mold cavity first portion. The mold cavity first portion has a size and shape corresponding to a size and shape of the first face label. A polymeric layer first portion is deposited in the mold cavity first portion on a back surface of the first face label. A polymeric layer second portion is deposited in a mold cavity second portion of the mold. The mold cavity second portion abuts the mold cavity first portion and is shaped so as to define a handle. A first face of the filter media is positioned on the polymeric layer first portion in the mold cavity first portion within a predetermined time. The filter media is removed from the mold cavity first portion with the polymeric layer first portion attached to the first face of the filter media and the back surface of the first face label attached to the polymeric layer first portion, and the polymeric layer second portion attached the polymeric layer first portion. The removing of the filter media from the mold cavity first portion causes the polymeric layer first portion, the first face label and the polymeric layer second portion to be removed from the mold cavity first portion and the mold cavity second portion, respectively along with the filter media such that the polymeric layer second portion extending axially from an edge of the polymeric layer first portion so as to define a handle of the filter element.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic flow diagram of a method of forming a filter element having at least a portion of a filter media thereof encased in a polymeric layer, according to an embodiment.

FIG. 2 is a schematic flow diagram of another method of forming a filter element having a plurality of faces of a filter media of the filter element encased in a wrapping layer that includes a polymeric layer, according to another embodiment.

FIG. 3 is a schematic illustration of a filter element, according to an embodiment

FIG. 4 is a schematic illustration of a process for encapsulating a plurality of faces of a filter media in a wrapping layer that includes a polymeric layer so as to form the filter element of FIG. 3, according to a particular embodiment.

FIG. 5 is a perspective view of a filter element comprising a filter media having a wrapping layer wrapped therearound\

FIG. 6 is a side view of a cylindrical filter media and an assembly for wrapping the cylindrical filter media in a wrapping layer that includes a polymeric layer and a base layer, according to another embodiment.

FIG. 7 is a schematic flow diagram of a method of forming a filter element having at least a portion of a filter media thereof encased in a polymeric layer, according to an embodiment.

FIG. 8 is schematic illustration of a filter element, according to another embodiment.

FIG. 9 is a process flow for forming the filter element of FIG. 8, according to a specific embodiment.

FIG. 10A is a top perspective view of a mold which may be used to wrap a polymeric layer around at least a portion of a filter media; and FIG. 10B is a top view of a portion of the mold of FIG. 10A indicated by the arrow B in FIG. 10A.

FIG. 11 is a schematic illustration of a trapezoidal filter element, according to a particular embodiment.

FIG. 12 is top-perspective via of a seal mold which may be used to mold a seal on a first face of a filter media and/or mold a perimeter seal member around the filter media, according to a particular embodiment.

FIG. 13 is a schematic flow diagram of an example method for forming a polymeric layer and sealing on one or more faces of a filter media, according to an embodiment.

FIG. 14 is a schematic flow diagram of an example method for forming a polymeric layer and a perimeter seal member on one or more faces of a filter media, according to another embodiment.

FIG. 15 is a process flow diagram illustrating various operations of the method of FIG. 14.

FIG. 16 is a schematic flow diagram of an example method for forming a polymeric layer and a perimeter seal member on one or more faces of a filter media, according to yet another embodiment.

FIG. 17 is a process flow diagram is a process flow diagram illustrating the operations of the method of FIG. 16.

FIG. 18 is a process flow diagram for forming a polymeric layer and a perimeter seal member on one or more faces of a filter media, according to a particular embodiment.

FIG. 19 is a process flow diagram for forming a polymeric layer and a perimeter seal member on one or more faces of a filter media, according to another embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to systems and methods for encapsulating at least a portion of a filter media in a polymeric layer. In particular, systems and methods described herein provide for depositing a polymeric layer on a base layer so as to form a wrapping layer, and wrapping the wrapping layer around the filter media. Other systems and methods described herein provide for depositing a polymeric layer in a mold cavity of a mold and embedding the filter media in the polymeric layer deposited in the mold cavity so as to wrap the polymeric layer around at least a portion of the filter media.

A number of conventional filter elements include a filter media such as pleated filter media, or a filter media including a stack of filter media layers (e.g., corrugated filter media layers). Such filter elements are often wrapped in wrapping layer, for example a cardboard layer so as to secure the filter media, for example, maintain a position of the pleats of the filter media or prevent the filter media layers in the stack from being separated from each other. Such wrapping layers may be aesthetically pleasing and may be suitable for printing markings (e.g., company name and logo) thereon. However, such wrapping layers are susceptible to mechanical damage such as tearing or puncturing during handling or installation.

Another design challenge is sealing of a trailing edge of a cylindrical filter media that includes a coiled filter media strip, or the cut ends of a cubed filter media which includes a stack of filter media layers. For the cylindrical filter media, the trailing edge may simply be taped or sealed with a bead of adhesive such as hot melt. For stacked media packs, the sealing process is much more challenging. Two entire faces of the cubed filter media have to be sealed. Furthermore, multiple adhesive beads may be needed under the wrap to prevent the wrap from tearing under vibration, and during maintenance or handling.

Other conventional filter elements, such as in-line flow air filters include a filter media that may comprise a corrugated filter media sheet adhered to a flat sheet. When manufactured in cubic form, the filter media sheet is cut in panels which are stacked and sealed into a block so as to form the cubed filter media. Two of the faces of this block may have to be sealed. The faces may be sealed by potting them into a mold where a polymeric material (e.g., polyurethane) has been poured. The polymeric material used in conventional potting operations for such filter media generally takes several minutes to set up, and several molds are typically required to maintain a reasonable production line rate. For example, a dispense rate of 15-30 g/sec is common with a cure time of about 5 minutes. If molds are indexed every 6 seconds, 50 molds would be required on the production line. Furthermore, the polymeric material is typically foamed to insure that it reaches well into the filter media so as to allow for movement of the polymeric material in the liquid state as the molds are transferred around a line or carousel. The foamed polymeric material is difficult to control and thus results in an uneven surface finish, resulting in poor aesthetics and reduced filtration performance due to blocked media.

Embodiments of the system and methods described herein for providing a wrapping layer around at least a portion of a filter media may provide benefits including, for example: (1) providing wrapping layer that includes a polymer layer wrapped around at least a portion of the filter media, thereby protecting the filter media from mechanical damage; (2) providing an outer base layer which is positioned on the outside of the filter element and provides an aesthetically pleasing surface as well as facilitates markings and/or placement of indicia thereon; (3) spray coating a mold cavity of a mold with a polymeric layer which is not foamed, thereby providing a smoother surface finish on the filter media potted therein; (4) providing a trim ledge on the mold which thins any polymeric layer flash, thereby facilitating removal of the polymeric layer flash; and (5) using a polymeric layer formulated to provide a faster dispense time and setting time, thereby faster molding operations using significantly less number of molds.

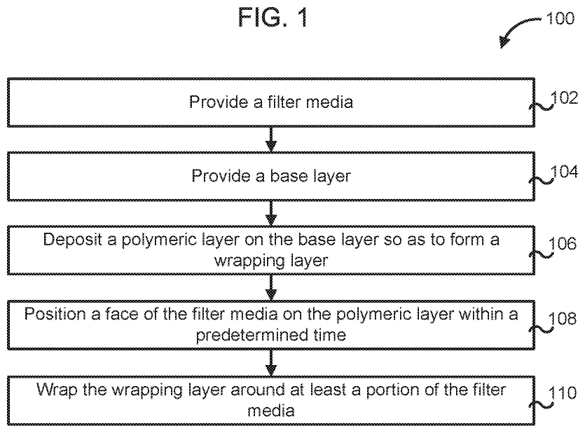

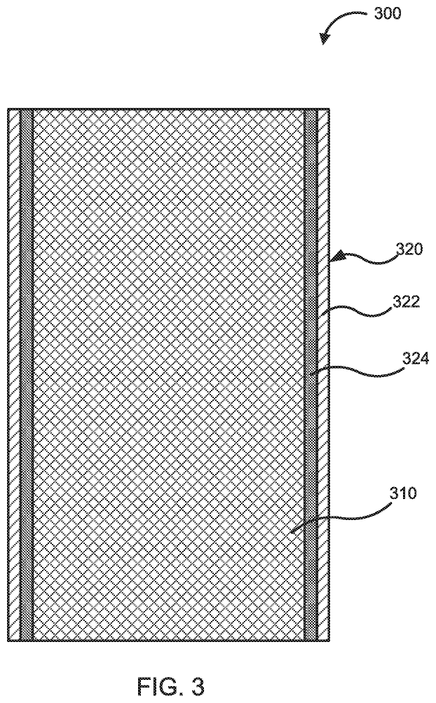

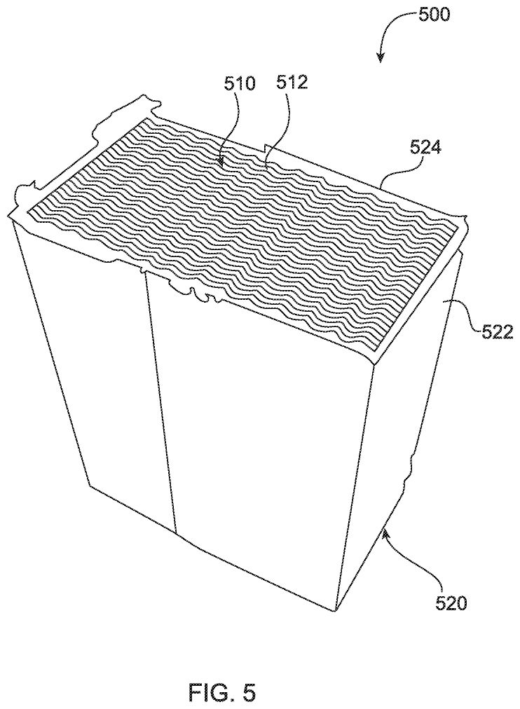

FIG. 1 is a schematic flow diagram of an example method 100 of forming a filter element (e.g., the filter element 300, 500 shown in FIGS. 3 and 5, respectively) such that at least a portion of a filter media (e.g., the filter media 310, 510, 610 shown in FIGS. 3, 6 and 7 respectively) of the filter element is encased in a polymeric layer, according to an embodiment.

The method 100 comprises providing the filter media, at 102. The filter media comprises a porous material having a predetermined pore size, and is configured to filter particulate matter from a fluid flowing therethrough (e.g., air or an air-fuel mixture). In some embodiments, the filter media may comprise a cylindrical filter media, for example, a coiled filter media including a filter media layer coiled or rolled into a cylindrical shape. In other embodiments, the filter media may comprise a cubed filter media, for example, comprise a plurality of filter media layers stacked into a cubic shape (e.g., a rectangular or square cube).

The filter media described in method 100 or any other filter media described herein may include pleated media, corrugated media, tetrahedral media, fluted filter media or variations thereof. U.S. Pat. No. 8,397,920, entitled “PLEATED FILTER ELEMENT WITH TAPERING BEND LINES,” by Moy et al., filed on Oct. 14, 2011, and issued on Mar. 19, 2013, assigned to Cummins Filtration IP Inc., which is incorporated by reference in its entirety and for all purposes, describes a tetrahedral filter media. Some configurations of tetrahedral filter media include a plurality of inlet tetrahedron flow channels and a plurality of outlet tetrahedron flow channels. The inlet tetrahedron merge in a central portion of the filter material thereby allowing axial cross-flow of air between the inlet tetrahedron channels prior to the air passing through the filter media. Such an arrangement provides for additional dust loading on the upstream side of the media, which increases filter capacity. The filter media may be wound around a central tube, which is closed on both ends. A top end of the central tube may be closed by an upper member when the filter element including the filter media is received within a housing in an installed position. A bottom end of the central tube may be closed by a cap.

A base layer is provided, at 104. The base layer (e.g., the base layer 322, 522, 622 shown in FIGS. 3, 6 and 7 respectively) may comprise, for example a cardboard layer, a paper layer, or any other layer which is susceptible to damage, for example, mechanical damage such as tearing and puncturing, or other kinds of damage such as wetting due to water exposure. The base layer, for example, a cardboard layer, may be suitable for printing images or text thereon (e.g., logos, part numbers, installation instructions, marketing information, indicia, decals, etc.). In some embodiments, an adhesive strip or adhesive bead may be provided on a base layer first surface proximate to an edge thereof.

A polymeric layer is deposited on the base layer so as to form a wrapping layer, at 106. For example, the polymeric layer may be in fluid form (e.g., dissolved in solvent to form a sprayable liquid) or is spray coated on the base layer first surface. In some embodiments, the polymeric layer may be deposited on the entire base layer first surface so as to cover the edges thereof and, thereby any adhesive strip or bead disposed thereon. In other embodiments, the polymeric layer may be deposited on the base layer first surface so as to partially cover the base layer first surface such that the adhesive strip or adhesive bead remains exposed. In particular embodiments, the polymeric layer is deposited on the base layer first surface so as to cover at least 80% of the base layer first surface.

Any suitable polymeric material may be used. Suitable polymeric materials include but are not limited to polyurethane, polyurea, polyvinyl alcohol, polytetrafluoroethylene, high density polyethylene, polyvinyl chloride, a thermoset polymer, a reinforced polymer, or a combination thereof. In particular embodiments, the polymeric layer comprises a polyurethane formulated to set within a predetermined time, for example, in a range of 10-20 seconds. In a specific embodiment, the polymeric material includes BASF® ElastoCast 555090. The predetermined time may correspond to a reaction or cross-linking time of the polyurethane monomer. The polymeric material may be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid.

A face of the filter media is positioned on the polymeric layer within the predetermined time, at 108. For example, the filter media may include a coiled filter media and may be positioned tangentially on the polymeric layer deposited on the base layer. In other embodiments, the filter media may comprise a cubed filter media including a plurality of faces, and a first face of the plurality of faces is positioned on the polymeric layer within the predetermined time. Positioning of the filter media on the polymeric layer may cause the polymeric layer, for example a liquid, a non-Newtonian liquid, a Bingham liquid, or a semi-solid polymeric layer, to penetrate folds of the filter media or generally adhere to an outer surface of the filter media. The predetermined time (e.g., in a range of 10-20 seconds) may be a minimum time period within which the polymeric layer starts to set (i.e., reacts or crosslinks). In other embodiments, the polymeric layer at least partially sets (e.g., turns from a sprayable liquid to a semi-solid due to cross-linking) within the predetermined time so as to facilitate embedding or potting of the face of the filter media therein when the filter media is positioned on the polymeric layer.

The wrapping layer is wrapped around at least a portion of the filter media, at 110. For example, the filter media may comprise a cylindrical filter media and the wrapping layer may be wrapped around at least a portion of the cylindrical filter media, for example by rolling the cylindrical filter media on the polymeric layer of the wrapping layer. In other embodiments, the filter media may comprise a cubed filter media and the wrapping layer may be folded at edges of the cubed filter media, so as to wrap the wrapping layer around at least a portion of the cubed filter media. In such embodiments, scoring or notches may be provided on the polymeric layer at locations thereof proximate to the edges of the face of the filter media, so as to facilitate bending of the wrapping layer about the notches.

In some embodiments, the ends of the wrapping layer may be bonded to each other (e.g., if a single wrapping layer is wrapped around the filter media), to a corresponding face of the filter media, or to corresponding ends of a second wrapping layer wrapped around another portion of the filter media. For example, the one or more wrapping layers may include an exposed adhesive bead or strip on at least one end which is bonded to an opposite end thereof, or a corresponding end of another wrapping layer so as to achieve the bonding. In other embodiments, bonding may be achieved by applying an adhesive to the ends, by heat bonding or by fusion bonding. In still other embodiments, the polymeric layer may be coated over the entire surface of the base layer. The ends of the wrapping layers may be overlapped before the polymeric layer sets such that the polymeric layer at one end overlaps, and adheres to the base layer of the opposite end of the wrapping layer (or a corresponding end of a second wrapping layer) as the polymeric layer sets, thereby bonding the ends of the wrapping layer. In particular embodiments, a perimeter seal member formed from a polymeric material (e.g., the polymeric material of the polymeric layer) may also be formed (e.g., molded) around at least one face of the filter media. The perimeter seal member provide a fluidic seal between the filter media and a filter housing (e.g., form a fluid seal with a sidewall of the filter housing) when the filter media is positioned within the filter housing.

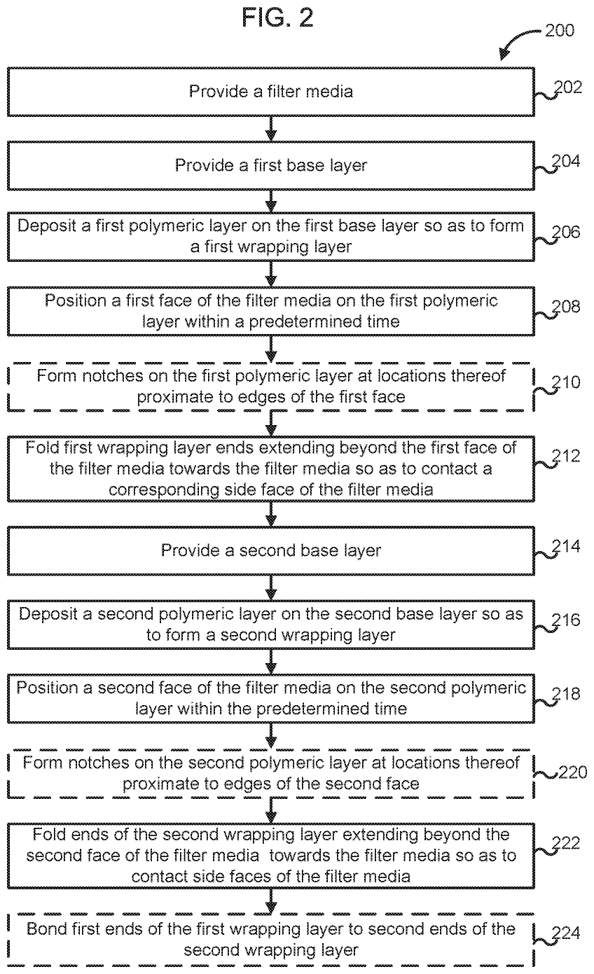

FIG. 2 is a schematic flow diagram of another example method 200 of forming a filter element (e.g., the filter element 300, 500) such that a plurality of faces of a cubed filter media (e.g., the filter media 310, 510) of the filter element are encased in a wrapping layer (e.g., the wrapping layer 320, 520) that includes a polymeric layer (e.g., the polymeric layer 324, 524), according to a particular embodiment. The method 200 comprises providing the filter media, at 202. The filter media includes a cubed filter media having a plurality of faces. For example, the filter media may include a plurality of filter media layers that are stacked so as to form the cubed filter media.

A first base layer is provided, at 204. The first base layer (e.g., the base layer 322, 522) may comprise, for example a cardboard layer, a paper layer, or any other layer which is susceptible to damage, for example, mechanical damage such as tearing and puncturing, or other kinds of damage such as wetting due to water exposure. The first base layer, for example a cardboard layer may be suitable for printing images or text thereon (e.g., logos, part numbers, installation instructions, marketing information, etc.). In some embodiments, an adhesive strip or adhesive bead may be provided on a base layer first surface proximate to an edge thereof.

A first polymeric layer is deposited on the base layer so as to form a first wrapping layer, at 206. For example, the first polymeric layer may be in fluid form (e.g., dissolved in solvent to form a sprayable liquid) or is spray coated on a first base layer first surface. In some embodiments, the first polymeric layer may be deposited on the entire base layer first surface so as to cover the edges thereof and, thereby any adhesive strip or bead disposed thereon. In other embodiments, the first polymeric layer may be deposited on the first base layer first surface so as to partially cover the first base layer first surface such that the adhesive strip or adhesive bead remains exposed. In particular embodiments, the first polymeric layer is deposited on the first base layer first surface so as to cover at least 80% of the first base layer first surface.

Any suitable polymeric material may be used for forming the first polymeric layer. Suitable polymeric materials include but are not limited to polyurethane, polyurea, polyvinyl alcohol, polytetrafluoroethylene, high density polyethylene, polyvinyl chloride, a thermoset polymer, a reinforced polymer, or a combination thereof. In particular embodiments, the first polymeric layer comprises a polyurethane formulated to set after a predetermined time, for example less than or equal to 20 seconds. In a specific embodiment, the polymeric material includes BASF® ElastoCast 555090. The polymeric material may be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid.

A first face of the filter media is positioned on the first polymeric layer within the predetermined time, at 208. Positioning of the filter media on the first polymeric layer may cause the first polymeric layer, for example a liquid, a non-Newtonian liquid, a Bingham liquid, or a semi-solid polymeric layer to penetrate folds of the filter media formed in the first face, or generally stick to an first face of the filter media. The predetermined time (e.g., in a range of 10-20 seconds) may be a minimum time period after which the polymeric layer starts to set (i.e., reacts or crosslinks). In other embodiments, the first polymeric layer may partially set (e.g., turns from a sprayable liquid to a semi-solid) within the predetermine time, so as to facilitate embedding or potting of the first face of the filter media therein when the filter media is positioned on the first polymeric layer.

In particular embodiments, notches may be formed on the first polymeric layer at locations thereof proximate to edges of the first face of the filter media, at 210. The notches may be formed, for example, by scoring the first polymeric layer (e.g., using a sharp object such as a blade or knife) so as to form axial notches, indentations, or grooves on the first polymeric layer proximate to the edges of the first face of the filter media. The notches may facilitate bending of the first wrapping layer thereabout.

First wrapping layer ends of the first wrapping layer extending beyond the first face of the filter media are folded towards the filter media so as to contact a corresponding side face of the filter media, at 212. For example, the first wrapping layer ends may be folded about the notches formed on the first polymeric layer towards the filter media, so as to contact a corresponding side face thereof. In particular embodiments, operation 212 may also be performed within the predetermined time (e.g., in a range of 10-20 seconds), for example, to allow the portion of the first polymeric layer deposited on the first wrapping layer ends, to contact and adhere to the corresponding side face of the filter media. Furthermore, the first wrapping layer ends may have lengths so as to contact only a portion of the side face of the filter media. In particular embodiments, a portion of the first polymeric layer may extend beyond the first layer, i.e., first polymeric layer flash may be formed. In such embodiments, the method 200 may also include trimming the first polymer layer flash. A jig or fixture may be used for trimming the first polymer layer flash.

A second base layer is provided, at 214. The second base layer may be substantially similar to the first base layer and therefore, not described in further detail herein. A second polymeric layer is deposited on the second base layer so as to form a second wrapping layer, at 216. For example, the second polymeric layer may be in fluid form (e.g., dissolved in solvent to form a sprayable liquid) or is spray coated on a second base layer first surface. In some embodiments, the second polymeric layer may be deposited on the entire second base layer first surface so as to cover the edges thereof and, thereby any adhesive strip or bead disposed thereon. In other embodiments, the second polymeric layer may be deposited on the second base layer first surface so as to partially cover the second base layer first, as previously described with respect to the first polymeric layer and the first base layer. In particular embodiments, the second polymeric layer is deposited on the second base layer first surface so as to cover at least 80% of the second base layer first surface. The second polymeric layer may be substantially similar to the first polymeric layer and therefore, not described in further detail herein.

A second face of the filter media opposite the first face, is positioned on the second polymeric layer within the predetermined time, at 218, as previously described with respect to the first polymeric layer. In particular embodiments, notches may also be formed on the second polymeric layer at locations thereof proximate to edges of the second face of the filter media, at 220, as previously described herein with respect to the first polymeric layer.

Second wrapping layer ends of the second wrapping layer extending beyond the second face of the filter media are folded towards the filter media so as to contact a corresponding side face of the filter media, at 222. For example, the second wrapping layer ends may be folded about the notches formed on the second polymeric layer towards the filter media so as to contact a corresponding side face thereof. In particular embodiments, operation 212 may also be performed within the predetermined time (e.g., in a range of 10-20 seconds), for example, to allow the portion of the second polymeric layer deposited on the second wrapping layer ends to contact and adhere to the corresponding side face of the filter media. Furthermore, the second wrapping layer ends may have lengths so as to contact only a portion of the side face of the filter media. In particular embodiments, a portion of the second polymeric layer may extend beyond the second base layer, i.e., second polymeric layer flash may be formed. In such embodiments, the method 200 may also include trimming the second polymer layer flash. In particular embodiments, the first polymeric layer flash and the second polymeric layer flash may be trimmed simultaneously.

In particular embodiments, the first wrapping layer ends of the first wrapping layer are bonded to the second wrapping layer ends of the second wrapping layer, at 224. Expanding further, the first wrapping layer ends of the first wrapping layer and the second wrapping layer ends of the second wrapping layer may be bonded to each other, and/or to a corresponding side face of the filter media. For example, the first and second wrapping layers may include an exposed adhesive bead or strip on at least one end thereof (e.g., the first wrapping layer end and/or the second wrapping layer end) which is bonded to the corresponding end of the other wrapping layer so as to achieve the bonding. In other embodiments, bonding may be achieved by applying an adhesive to the first wrapping layer end and/or the second wrapping layer end, by heat bonding or by fusion bonding. In still other embodiments, the polymeric layers may be coated over the entire surface of the base layers. The ends of the wrapping layers may be overlapped before the polymeric layers set such that the first polymeric layers at the first wrapping layer end overlaps, and adheres to the second base layer of the second wrapping layer end (or vice versa) as the polymeric layers set, thereby bonding the ends of the wrapping layers.

FIG. 3 is a cross-sectional schematic illustration of a filter element 300, according to a particular embodiment. The filter element 300 comprises a filter media 310, and a wrapping layer 320 positioned around a portion of the filter media. The filter media 310 includes a cubed filter media comprising a stack of filter media layers, a pleated filter media, or any other filter media as previously described herein. The wrapping layer 320 comprises a base layer 322 and a polymeric layer 324. The base layer 322 may include a card board layer or any other base layer, as previously described herein with respect to the methods 100 and 200. The polymeric layer 324 is positioned between the base layer 322 and the filter media 310, and is in contact with and adheres to the filter media 310. The polymeric layer 324 may include any suitable polymeric layer, for example the polymeric layers described in detail with respect to methods 100 and 200. In particular embodiments, the polymeric layer 324 may comprise a polyurethane layer which sets within a predetermined time, for example, in a range of 10-20 seconds. While FIG. 3 shows the filter element 300 as including a single wrapping layer 320, in other embodiments, the filter element 300 may include a plurality of wrapping layers positioned on various faces of the filter media 310. In still other embodiments, the filter element 300 may include other components including, but not limited to a center tube and/or end caps.

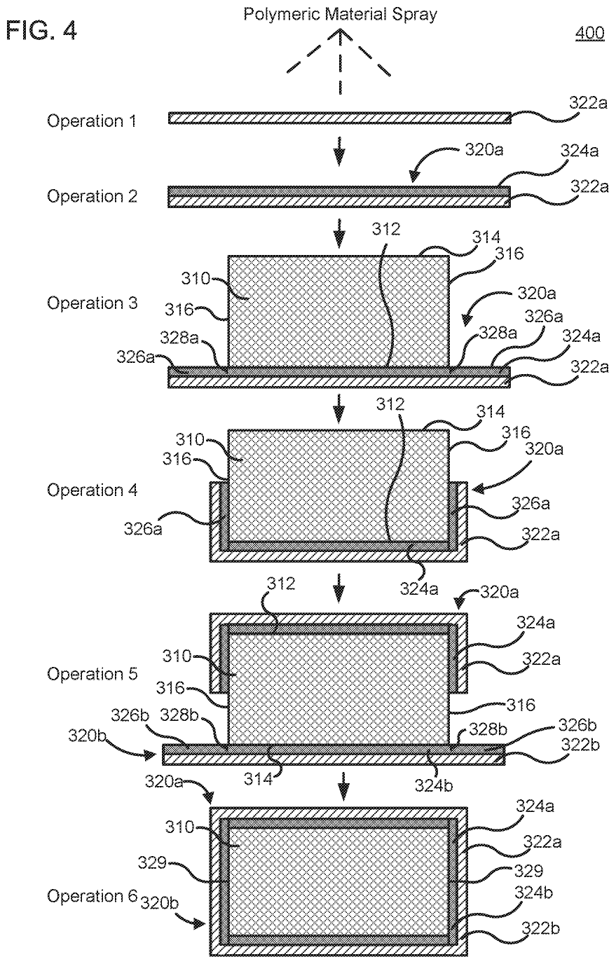

FIG. 4 is a schematic illustration of a process 400 that may be used for encapsulating a plurality of faces of a cubed filter media, in a plurality of wrapping layers so as to form the filter element 300 of FIG. 3, according to a particular embodiment. The process 400 comprises depositing (e.g., spraying) a polymeric material on a first base layer 322a, at operation 1. The deposited polymeric material forms a first polymeric layer 324a on the first base layer 322a, thereby forming a first wrapping layer 320a, at operation 2. The first base layer 322a may include, for example a cardboard layer, a paper layer, or any other layer which is susceptible to mechanical damage, for example tearing or puncturing. The first base layer 322a, for example a cardboard layer may suitable for printing images or text thereon (e.g., logos, part numbers, installation instructions, marketing information, etc.). In some embodiments, an adhesive strip or adhesive bead may be provided on the first base layer 322a proximate to an edge thereof.

The polymeric material may be in fluid form (e.g., dissolved in solvent to form a sprayable liquid) or is spray coated on a first base layer 322a so as to form the first polymeric layer 324a thereon. In some embodiments, the polymeric material may be deposited on the first base layer 322a such that the first polymeric layer may covers the edges thereof of the first base layer 322a and, thereby any adhesive strip or bead disposed thereon. In other embodiments, the polymeric material may be deposited on the first base layer 322a so as to partially cover the first base layer 322a such that the adhesive strip or adhesive is not covered with the first polymeric layer 324a. In particular embodiments, the polymeric material is deposited on the first base layer such that the first polymeric layer 324a covers at least 80% of the first base layer 322a.

Any suitable polymeric material may be used for forming the first polymeric layer 324a., for example any of the polymeric materials described with respect to the methods 100 and 200. The polymeric material may be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid.

As described before, the filter media 310 may include a cubed filter media having a plurality of faces. A first face 312 of the filter media 310 is positioned on the first polymeric layer 324a within a predetermined time, at operation 3. Positioning of the first face 312 of the filter media 310 on the first polymeric layer 324a may cause the first polymeric layer 324a, for example a liquid, a non-Newtonian liquid, a Bingham liquid, or a semi-solid polymeric layer to penetrate folds of the filter media formed in the first face 312, or generally stick to the first face 312 of the filter media 310. The predetermined time (e.g., in a range of 10-20 seconds) may be a minimum time period after which the first polymeric layer 324a starts to set (i.e., reacts or crosslinks). In other embodiments, the first polymeric layer 324a may at least partially set (e.g., turns from a sprayable liquid to a semi-solid) within the predetermined time so as to facilitate embedding or potting of the first face 312 of the filter media 310 therein when the first face 312 of the filter media 310 is positioned on the first polymeric layer 324a.

In particular embodiments, notches 328a may be formed on the first polymeric layer 324a at locations thereof proximate to edges of the first face 312 of the filter media 310, as shown in operation 3. The notches 328a may be formed, for example, by scoring the first polymeric layer (e.g., using a sharp object such as a blade or knife) so as to form axial notches, indentations, or grooves on the first polymeric layer 324a proximate to the edges of the first face 312 of the filter media 310. The notches 328a may facilitate bending of the first wrapping layer 320a thereabout.

First wrapping layer ends 326a of the first wrapping layer 320a extending beyond the first face 312 of the filter media 310 are folded towards the filter media 310 so as to contact a corresponding side face 316 of the filter media 310, at operation 4. For example, the first wrapping layer ends 326a may be folded about the notches 328a formed on the first polymeric layer 324a towards the filter media 310 so as to contact a corresponding side face 316 thereof. In particular embodiments, operation 4 may also be performed within the predetermined time (e.g., in a range of 10-20 seconds), for example, to allow the portion of the first polymeric layer 324a deposited on the first wrapping layer ends 326a to contact and adhere to the corresponding side face 316 of the filter media 310. Furthermore, the first wrapping layer ends 326a may have lengths so as to contact only a portion of the corresponding side faces 316 of the filter media 310, for example, at least 50% of the corresponding side face 316. In particular embodiments, a portion of the first polymeric layer 324a may extend beyond the first base layer 322a, i.e., first polymeric layer flash may be formed. In such embodiments, the first polymer layer flash may be trimmed, for example using a knife, a blade, or a fixture.

At operation 5, a second face 314 of the filter media 310 opposite the first face 312, is positioned on a second polymeric layer 324b of a second wrapping layer 320b within a second predetermined time, as previously described with respect to the first polymeric layer 324a. The second wrapping layer 320b includes a second base layer 322b having the second polymeric layer 324b deposited thereon. The second wrapping layer 320b may be substantially similar to the first wrapping layer 320a and formed using the operations described in operations 1 and 2 (i.e., spray coating the polymeric material on the second base layer 322b). Furthermore, the second predetermined time may be the same as the predetermined time (e.g., in a range of 10-20 seconds). In particular embodiments, notches 328b may also be formed on the second polymeric layer 324b at locations thereof proximate to edges of the second face 314 of the filter media 310, as previously described herein with respect to the first polymeric layer 324a.

Second wrapping layer ends 326b of the second wrapping layer 320b extending beyond the second face 314 of the filter media 310 are folded towards the filter media 310 so as to contact the corresponding side face 316 of the filter media 310, at operation 6. For example, the second wrapping layer ends 326b may be folded about the notches 328b formed on the second polymeric layer 324b towards the filter media 310 so as to contact the corresponding side face 316 thereof. In particular embodiments, operation 5 may also be performed within the second predetermined time (e.g., in the range of 10-20 seconds), for example, to allow the portion of the second polymeric layer 324b deposited on the second wrapping layer ends 326b to contact and adhere to the corresponding side face 316 of the filter media 310. Furthermore, the second wrapping layer ends 326b may have lengths so as to contact only a portion of the side face 316 of the filter media 310, for example, at least 50% of the corresponding side face 316. In particular embodiments, a portion of the second polymeric layer 324b may extend beyond the second base layer 322b, i.e., second polymeric layer flash may be formed. The second polymeric layer flash may be trimmed, as previously described with respect to the first polymeric layer 324a.

In particular embodiments, the first wrapping layer ends 326a of the first wrapping layer 320a are bonded to the second wrapping layer ends 326b of the second wrapping layer 320b. For example, the first wrapping layer ends 326a and the second wrapping layer ends 326b may have lengths such that a first wrapping layer end 326a and the corresponding second wrapping layer end 326b abut or overlap at an interface 329. The first wrapping layer end 326a may be bonded to the second wrapping layer end 326b at the interface 329 so as to secure the first wrapping layer 320a and the second wrapping layer 320b to the filter media 310.

In some embodiments, the first and second wrapping layers 320a/b may include an exposed adhesive bead or strip on at least one end (e.g., the first wrapping layer end 326a and/or the second wrapping layer end 326b) thereof, which is bonded to the corresponding end (e.g., the first wrapping layer end 360a or the second wrapping layer end 326b) of the other wrapping layer so as to achieve the bonding. In other embodiments, bonding may be achieved by applying an adhesive on the interface 329, by heat bonding or fusion bonding. In still other embodiments, the polymeric layers 324a/b may be coated over the entire surface of the base layers 322a/b. The wrapping layer ends 326a/b of the wrapping layers 320a/b may be overlapped before the polymeric layers 324a/b set (e.g., within the predetermined time) such that a portion of the first polymeric layer 324a disposed on the first wrapping layer end 326a, overlaps and adheres to the portion of the second base layer 322b positioned at the second wrapping layer end 326b (or vice versa) as the polymeric layers 324a/b set, thereby bonding the wrapping layer ends 326a/b of the wrapping layers 320a/b.

FIG. 5 is a perspective view of a filter element 500 comprising a filter media 510. The filter media 510 comprises a cubed filter media including a plurality of corrugated filter media layers 510, which are stacked so as to form the filter media 510. A wrapping layer 520 is wrapped around a portion of the filter media 510. The wrapping layer 520 comprises a cardboard base layer 522, and a polyurethane polymeric layer 524 interposed between the base layer 522 and a plurality of faces of the filter media 510, so as to be positioned on the plurality of faces of the filter media 510. The cardboard base layer 522 positioned on the outside is aesthetically superior to the underlying polyurethane polymeric layer 524, and is conducive to defining markings or positioning decal thereon, while the underlying polyurethane polymeric layer 524 provides protection against mechanical damage.

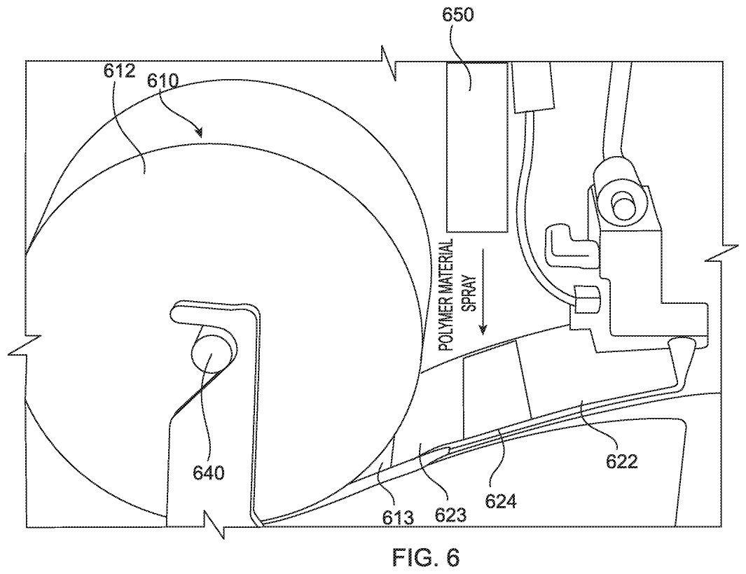

FIG. 6 is a side view of a cylindrical filter media 610, and an assembly for forming the cylindrical filter media 610 and wrapping the cylindrical filter media in a wrapping layer 620, according to another embodiment. The filter media 610 includes a filter media sheet 612. The filter media sheet 612 is coiled about an axle 640 into a roll, thereby forming the cylindrical filter media 610. The axle 640 may be coupled to a motor configured to rotate the axle 640 so as to roll the filter media sheet 612 in to the cylindrical filter media 610. The filter media sheet 612 may comprise a corrugated filter media sheet.

A filter media sheet end 613 of the filter media sheet 612 is coupled (e.g., bonded) to a base layer end 623 of a base layer 622. This allows the base layer 622 to be wrapped around the cylindrical filter media 610 after the filter media sheet 612 is finished coiling into the cylindrical filter media 610. In particular embodiments, the base layer 622 may include a cardboard sheet. In some embodiments, the base layer 622 may be separate from the filter media sheet 612 (i.e., not coupled thereto) and may be wrapped around the cylindrical filter media 610 after the filter media sheet 612 has been coiled to form the cylindrical filter media 610.

As shown in FIG. 6, the base layer 622 is sprayed with a polymeric material (e.g., polyurethane) via a sprayer 650, so as to form a polymeric layer 624 on the base layer 622. The polymeric material may be sprayed continuously on the base layer 622, as the base layer 622 is fed continuously around the cylindrical filter media 610. In this manner, the polymeric layer may be interposed between the base layer 622 and an outer surface of the cylindrical filter media 610, so as to provide mechanical protection thereto. In various embodiments, the rotation of the cylindrical filter media 610 about the axle 640, and a flow rate of the polymeric material spray may be adjusted so as to obtain a predetermined thickness of the polymeric layer 624 on the base layer 622. In particular embodiments, the base layer 622 may be formed from a tough material (e.g., thick cardboard, or metals). In such embodiments, a thickness of the polymeric layer 624 may be reduced so as to reduce an amount of the polymeric material (e.g., polyurethane) used on the cylindrical filter media 610 and/or to use the polymeric layer 624 primarily as a bonding layer (e.g., an adhesive).

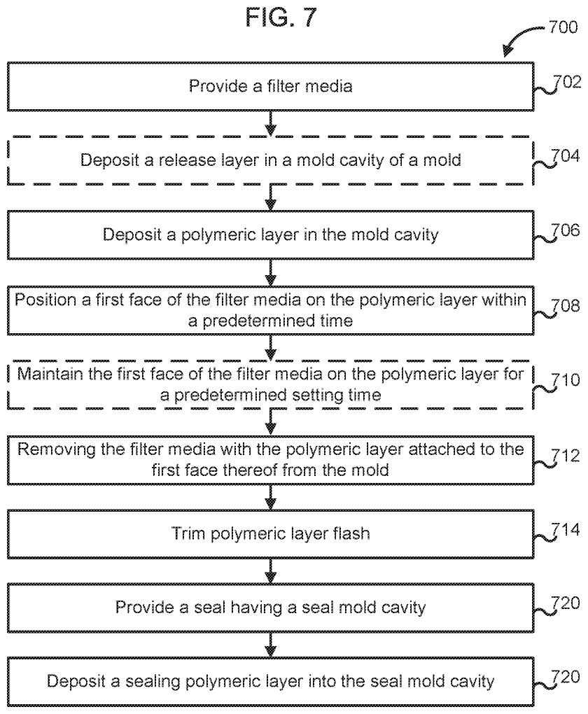

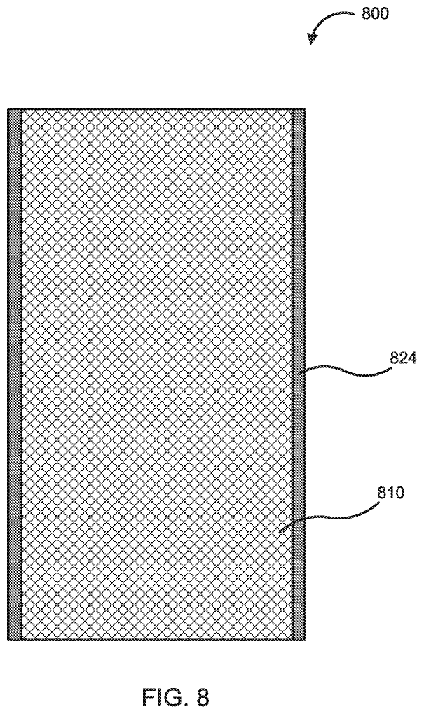

FIG. 7 is a schematic flow diagram of an example method 700 for forming a filter element (e.g., the filter element 800 shown in FIG. 8) having at least a portion of a filter media (e.g., the filter media 810 of FIG. 8) thereof encased in a polymeric layer (e.g., the polymeric layer 824 shown in FIG. 8), according to another embodiment.

The method 700 comprises providing the filter media, at 702. The filter media comprises a porous material having a predetermined pore size and is configured to filter particulate matter from a fluid flowing therethrough (e.g., air or an air-fuel mixture). The filter media may comprise a cubed filter media, for example, include a plurality of filter media layers stacked so as to form the cubed filter media. In particular embodiments, the plurality of filter media layers may be corrugated.

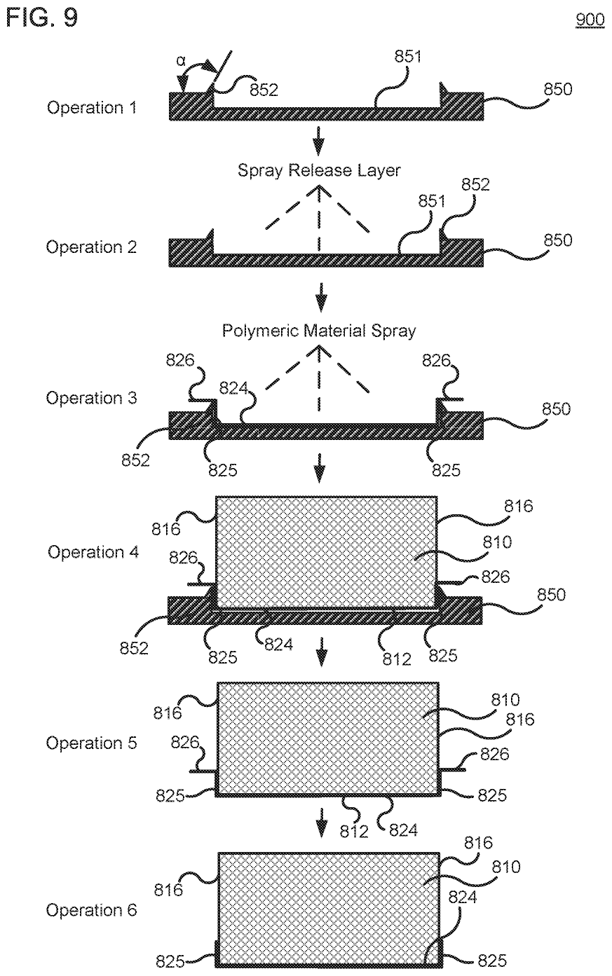

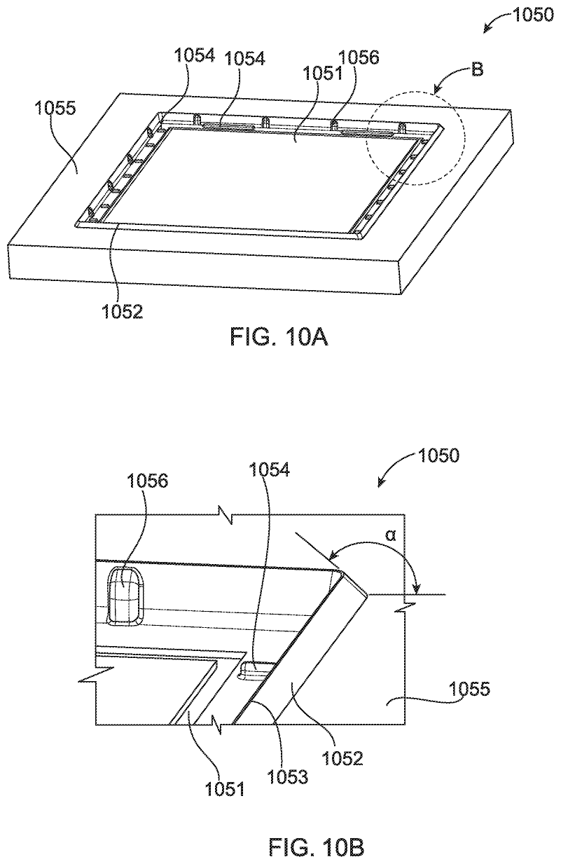

In some embodiments, a release layer is deposited in a mold cavity of a mold, at 704. The mold may include, for example, the mold 850, 1050 shown in FIGS. 9 and 10A-10B, respectively. The release layer may be formed from a low surface tension release agent, and may be sprayed into the mold cavity. Suitable release agents may include, but are not limited to silicone based releasing agent, a wax based releasing agent, sulfonic release agents, or any other release agents. In other embodiments, a surface of the mold cavity may be structured to provide self-release properties. For example, micro or nano sized features may be formed on the surface of the mold cavity, so as to reduce a contact angle of droplets of a polymeric layer sprayed or otherwise deposited into the mold cavity, so as to significantly reduce adhering of the polymeric layer to the surface of the mold cavity.

A polymeric layer is deposited into the mold cavity of the mold, at 706. For example, the polymeric layer may be in fluid form (e.g., dissolved in solvent to form a sprayable liquid) or is spray coated on the surface of the mold cavity (e.g., the mold cavity 851, 1051 of the mold 850, 1050, respectively). Any suitable polymeric material may be used. Suitable polymeric materials include but are not limited to polyurethane, polyurea, polyvinyl alcohol, polytetrafluoroethylene, high density polyethylene, polyvinyl chloride, a thermoset polymer, a reinforced polymer, or a combination thereof. In particular embodiments, the polymeric layer comprises a polyurethane formulated to set within a predetermined time, for example, within a range of 10-20 seconds. In a specific embodiment, the polymeric material includes BASF® ElastoCast 555090. The polymeric material may be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid.

A first face of the filter media is positioned on the polymeric layer within a predetermined time, at 708. For example, the filter media may comprise a cubed filter media including a plurality of faces, and a first face of the plurality of faces is positioned on the polymeric layer within the predetermined time. Positioning of the filter media on the polymeric layer may cause the polymeric layer, for example a liquid, a non-Newtonian liquid, a Bingham liquid, or a semi-solid polymeric layer to penetrate folds of the filter media or generally stick to an first face of the filter media. The predetermined time (e.g., in a range of 10-20 seconds) may be a time period within which the polymeric layer at least partially sets (i.e., reacts or crosslinks). In other embodiments, the polymeric layer may partially set (e.g., turns from a sprayable liquid to a semi-solid) within the predetermine time so as to facilitate embedding or potting of the first face of the filter media therein when the filter media is positioned on the polymeric layer.

In particular embodiments, the first face of the filter media may be maintained on the polymeric layer for a predetermined setting time, at 710. The polymeric layer may be formulated to set and adhere to the first face of the filter media within the predetermined setting time. For example, the predetermined setting time may include a time period that the polymeric layer takes to completely set (i.e., all the solvent evaporates and the polymeric layer completely solidifies) from the time point at which the first face of the filter media is positioned on the polymeric layer. In some embodiments, the predetermined setting time may be in a range of 5 seconds to 30 seconds after the predetermined time (e.g., 25 seconds to 50 seconds after the polymeric layer is deposited in the mold cavity.

The filter media is removed from the mold cavity with the polymeric layer attached to the first face thereof, at 712. Expanding further, removing of the filter media from the mold cavity causes the polymeric layer to be also removed from the mold cavity along with the filter media (e.g., facilitated by the release agent). In this manner, the first face of the filter media may be wrapped or otherwise encapsulated in a polymeric layer in a rapid and simple fashion.

In some embodiments, the method may also include trimming a polymeric layer flash from the polymeric layer, at 714. For example, the polymeric layer may include polymeric layer flash extending from ends of the polymeric layer. The polymeric layer flash may form during depositing (e.g., spray coating) of the mold into the mold cavity, for example, the polymeric material may flow over a rim of the mold cavity so as to form the polymeric layer flash. In other instances, the polymeric layer flash may be formed as the first face of the filter media is positioned on the polymeric layer. For example, the first face of the filter media may be pushed into the polymeric layer, causing a portion of the polymeric layer to flow around the first face beyond the rim of the mold cavity, and form the polymeric layer flash. The polymeric layer flash may not be attached to the filter media, and is trimmed off (e.g., using a knife, a blade, a fixture, or manually removed).

In some embodiments, the mold may comprise a trim ledge extending axially from a rim of the mold cavity. The trim ledge may be structured to reduce a thickness of the polymeric layer flash extending outside of the mold cavity, for example, to facilitate trimming of the polymeric flash layer. For example, an outer surface of the trim ledge may be inclined at an angle with respect to a top surface of the mold such that the trim ledge defines a sharp edge at an end thereof. In particular embodiments, the angle may be in a range of 120-135 degrees and may be angled inwards, outwards, or a combination thereof so as to form a sharp trim ledge. In some embodiments, the trim ledge may be structured to trim or deflash the polymeric layer flash during positioning of the filter media on the polymeric layer within the mold cavity.

In this manner, the first face of the filter media may be wrapped or otherwise encapsulated in the polymeric layer. The filter media may then be indexed or rotated so as to present a second face of the filter media towards the mold cavity of the mold, and the operations of method 700 may be repeated so as to wrap the second face of the filter media in the polymeric layer, and so on until all the desired faces of the filter media are wrapped in the polymeric layer. Robotic manipulators may be used to index the filter media making the process amenable to automation.

The operations of the method 700 described herein for encapsulating a filter media in a polymeric layer may be substantially faster and cheaper than conventional methods. For example, conventional methods for positioning polyurethane on filter media generally include a dispense rate of the polyurethane of 15-30 g/sec with a cure time of about 5 minutes. If molds are indexed every 6 seconds, 50 molds would be required on the production line using such conventional methods. In contrast, method described herein which deposit (e.g., spray) the polyurethane (or any other polymeric material) into the mold cavity may provide a dispense rate of the polyurethane into the mold cavity of between 70-140 g/sec with a cure time of about 20 seconds or less. With an index rate of 6 seconds, only four molds would be sufficient for encapsulating all the faces of the filter media in the polymeric layer, which is substantially faster and cheaper than conventional methods.

FIG. 8 is a schematic cross-sectional illustration of a filter element 800, according to a particular embodiment. The filter element comprises a filter media 810 and a polymeric layer 824 wrapped around the filter media 810. The filter media 810 may include a cubed filter media comprising a stack of filter media layers, a pleated filter media, or any other filter media as previously described herein. The polymeric layer 824 may include any suitable polymeric layer, for example the polymeric layers described in detail with respect to method 700. In particular embodiments, the polymeric layer 824 may comprise a polyurethane layer which sets within a predetermined time, for example, in a range of 10-20 seconds. While FIG. 8 shows the filter element 800 as including a single polymeric layer 824, in other embodiments, the filter element 800 may include a plurality of polymeric layers positioned on various faces of the filter media 810. In still other embodiments, the filter element 800 may include other components including, but not limited to a center tube and/or end caps.

FIG. 9 is a schematic illustration of a process 900 that may be used for encapsulating one or more faces of the filter media 810, for example a cubed filter media, in a polymeric layer so as to form the filter element 800 of FIG. 8, according to a particular embodiment. The process 900 comprises providing a mold 850, at operation 1. The mold 850 defines a mold cavity 851 which may be shaped and sized to correspond to the dimensions of a face of the filter media 810. A trim ledge 852 extends axially from a rim of the mold cavity 851. The trim ledge 852 is structured to reduce a thickness of a polymeric layer flash formed during the molding process, for example, to facilitate trimming of the polymeric flash layer. An outer surface of the trim ledge 852 is inclined at an angle α with respect to a top surface of the mold 850 such that the trim ledge 852 defines a sharp edge at an end thereof. In particular embodiments, the angle α may be in a range of 120-135 degrees. In some embodiments, the trim ledge 852 may be structured to trim or deflash the polymeric layer flash during positioning of the filter media on the polymeric layer within the mold cavity 851, as described below in further detail herein.

A release layer is sprayed into the mold cavity 851 of the mold 850, at operation 2. The release layer may be formed from a low surface tension release agent sprayed into the mold cavity. Suitable release agents may include, but are not limited to silicone based releasing agent, wax based releasing agent, sulfonic release agents, or any other release agents. In other embodiments, a surface of the mold cavity 851 may be structured to provide self-release properties. For example, micro or nano sized features may be formed on the surface of the mold cavity 851, so as to reduce a contact angle of droplets of the polymeric layer 824 sprayed or otherwise deposited into the mold cavity 851, so as to significantly reduce adhering of the polymeric layer 824 to the surface of the mold cavity 851.

A polymeric material is sprayed into the mold cavity 851 so as to form the polymeric layer 824, at operation 3. For example, the polymeric material may be in fluid form (e.g., dissolved in solvent to form a sprayable liquid) or is spray coated on the surface of the mold cavity 851. Any suitable polymeric material may be used. Suitable polymeric materials include but are not limited to polyurethane, polyurea, polyvinyl alcohol, polytetrafluoroethylene, high density polyethylene, polyvinyl chloride, a thermoset polymer, a reinforced polymer, or a combination thereof.

In particular embodiments, the polymeric layer comprises a polyurethane formulated to set within a predetermined time, for example, within a range of 10-20 seconds. In a specific embodiment, the polymeric material includes BASF® ElastoCast 555090. The polyurethane me be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid. A polymeric layer portion 825 is positioned on the sidewalls of the mold cavity 851, and may extend over the trim ledge 852 so as to form polymeric layer flash 826.

A first face 812 of the filter media 810 is positioned on the polymeric layer 824 within a predetermined time (e.g., in a range of 10-20 seconds), at operation 4. Positioning of the first face 812 of the filter media 810 on the polymeric layer 824 may cause the polymeric layer 824, for example a liquid, a non-Newtonian liquid, a Bingham liquid, or a semi-solid polymeric layer to penetrate folds of the filter media 810 or generally stick to the first face 812 of the filter media 810. Furthermore, the polymeric layer portion 825 may contact and adhere to a corresponding side face 816 of the filter media 810. In particular embodiments, the first face 812 of the filter media 810 may be maintained on the polymeric layer 824 for a predetermined setting time. The polymeric layer may be formulated to set and adhere to the first face of the filter media within the predetermined setting time, as previously described herein. In some instances, the polymeric layer 824 may exhibit Bingham liquid characteristics and may not self-level after being sprayed into the mold cavity 851. In such instances, the polymeric layer 824 may be spray coated on the mold cavity 851 such that minimum overlap exists between adjacent sprays of the polymeric layer 824 so as to increase uniformity. In other instances, the polymeric layer 824 may be sprayed so as to deliberately produce a non-uniform layer (e.g., produce patterns in the polymeric layer 824).

The filter media 810 is removed from the mold cavity 851 with the polymeric layer 824 attached to the first face 812 thereof, at operation 5. Removing of the filter media 810 from the mold cavity 851 causes the polymeric layer 824 to be also removed from the mold cavity 851 along with the filter media 810 (e.g., facilitated by the release agent). In this manner, the first face 812 of the filter media 810 may be wrapped or otherwise encapsulated in a polymeric layer 824 in a rapid and simple fashion.

The polymeric layer flash 826 is trimmed, at operation 6. As previously described herein, the polymeric layer flash 826 may be formed at operation 3, when the polymeric material is sprayed into the mold cavity 851, or when the first face 812 of the filter media 810 is positioned on the polymeric layer 824. For example, the first face 812 of the filter media 810 may be pushed into the polymeric layer 824, causing the polymeric layer portion 825 to flow beyond the rim of the mold cavity 851, and form the polymeric layer flash 826. The polymeric layer flash 826 may not be attached to the filter media 810, and is trimmed off (e.g., using a knife, a blade or a fixture, or manually stripped off).

In this manner, the first face 812 of the filter media 810 is wrapped or otherwise encapsulated in the polymeric layer 824. The filter media 810 may then be indexed or rotated to present another face of the filter media 810 (e.g., the side face 816) towards the mold cavity 851 of the mold 850. The operations of the process 900 may be repeated so as to wrap the face of the filter media 810 in the polymeric layer 824, and so on until all the desired faces of the filter media 810 are wrapped in the polymeric layer 824.

FIG. 10A is a top perspective view of a mold 1050 which may be used to wrap the polymeric layer 824 around at least a portion of a filter media 810 of the filter element 800. FIG. 10B is a top view of a portion of the mold 1050 of FIG. 10A indicated by the arrow B in FIG. 10A. The mold 1050 defines a mold cavity 1051 shaped and sized to correspond to the dimensions of a face of a filter media (e.g., the filter media 810). A plurality of axial standoffs 1054 extend from a bottom surface of the mold cavity 1051, and a plurality of radial standoffs 1056 are positioned around an inner perimeter of the mold cavity 1051. The plurality of axial standoffs 1054 and radial standoffs 1056 are configured to provide a gap between sidewalls of the mold cavity 1051 and the faces of the filter media inserted therein. The gaps may be filled with the polymeric layer (e.g., polyurethane) deposited in the mold cavity 1051, such that the gap may serve to define the thickness of the polymeric layer and/or facilitate removal of the filter media with the polymeric layer attached thereto from the mold cavity 1051. Markings or indicia (e.g., product name, company logo, serial number, etc.) may be etched on surface of the mold cavity, which are imprinted on the polymeric layer during the molding process.

A trim ledge 1052 extends axially from a rim of the mold cavity 1051. The trim ledge 1052 is structured to reduce a thickness of a polymeric layer flash formed during the molding process, for example, to facilitate trimming of the polymeric flash layer. In particular embodiments, the trim ledge 1052 may have a height in a range of 1.5-3.0 mm from a top surface 1055 of the mold 1050. An outer surface of the trim ledge 1052 is inclined at an angle α with respect to the top surface 1055 of the mold 1050 such that the trim ledge 1052 defines a sharp edge 1053 (e.g., define a sharp crest having a 0.25 mm maximum radius) at an end thereof. In particular embodiments, the angle α may be in a range of 120-135 degrees. In some embodiments, the trim ledge 1052 may be structured to trim or deflash the polymeric layer flash during positioning of the filter media on the polymeric layer within the mold cavity 1051. The trim ledge 1052 may provide a clean and uniform edge of the polymeric layer.

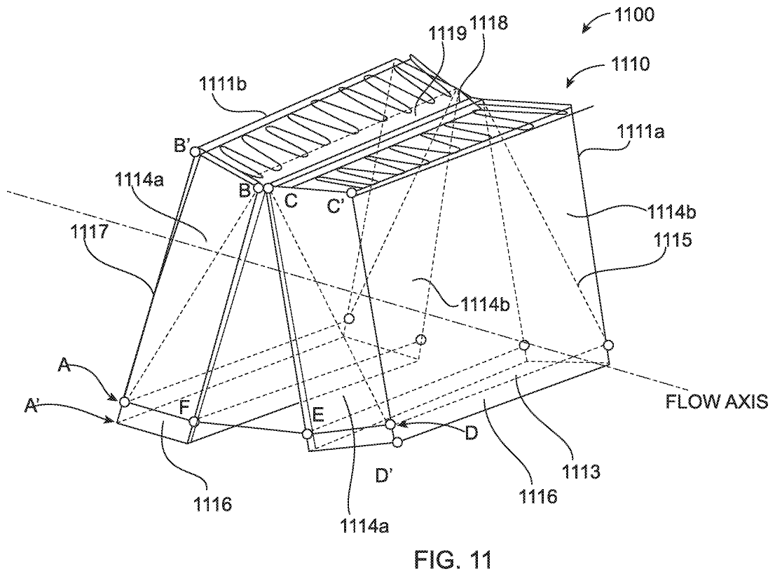

FIG. 11 is a schematic illustration of a filter element 1100, according to a particular embodiment. The filter element 1100 comprises a filter media 1110 having a first filter media panel 1111a and a second panel 1111b, each having a generally rectangular shape. First edges of the filter media panels 1111a/b are coupled together at an interface 1118, for example, via an adhesive ribbon 1119, while opposing edges of the filter media panels 1111a/b are spaced apart as shown in FIG. 11, such that the filter media 1110 is a V-shaped filter media having a generally trapezoidal shape.

In some embodiments, the filter media 1110 may comprise a pleated filter media. A first set of hot melt seal beads may be disposed at the ends of the line 1113 (e.g., to secure the pleats of the filter media 1110), and a second set of hot melt seal beads may be positioned at ends of the line 1115 (e.g., to facilitate securing of a polymeric layer and/or a perimeter seal member 1117 thereto), as shown in FIG. 11. Each of the filter media panels 1111a/b have a first face 1114a and a second face 1114b opposite the first face 1114a (e.g., sides faces of the filter media 1110), positioned parallel to a flow axis of the filter media 1110. Moreover, the filter media panels 1111a/b may also have an end face 1116 (e.g., a bottom end face) positioned perpendicular the first face 1114a and the second face 1114b.

In particular embodiments, a polymeric layer (e.g., a polyurethane or a polyurea layer) may be disposed on the first face 1114a and/or the second face 1114b, for example, in the area formed by the points AB′BCC′DEF shown in FIG. 11. Furthermore, a perimeter seal member 1117, for example, a polymeric layer (e.g., polyurethane or polyurea) perimeter seal member may also be positioned around the first face 1114a and/or the second face 1114b (e.g., around the outer edges of the first face 1114a and the second face 1114b, for example, along the points AB′BCC′DEF The perimeter seal member 1117 may be serve as a gasket configured to fluidly seal the first face 1114a and/or the second face 1114b when the filter media 1110 is positioned within a filter media housing. In other embodiments, a second perimeter seal member may be additionally, or alternatively positioned around the end face 1116 of the filter media 1110.

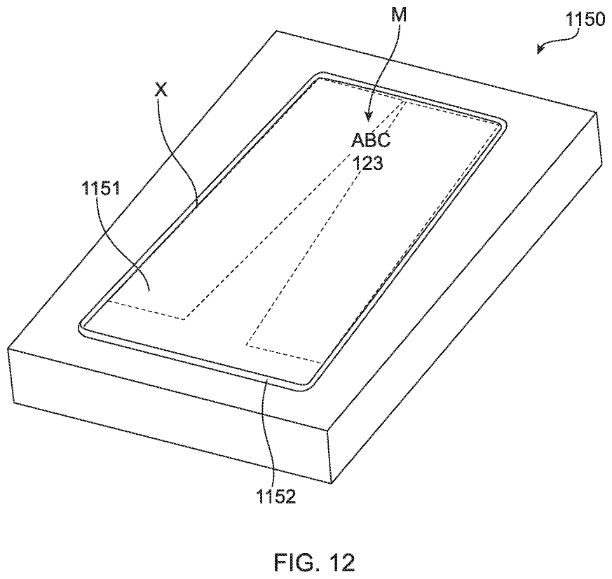

In some embodiments, a seal mold may be used to seal the first face 1114a and/or the second face 1114b of the filter media 1110 after a polymeric layer has been deposited thereon. For example, FIG. 12 is a top-perspective view of a seal mold 1150, according to a particular embodiment. The seal mold 1150 defines a seal mold cavity 1151 configured to receive the first face 1114a or the second face 1114b of the filter media 1110, as shown by the outline X shown in FIG. 12. The seal mold 1150 may also comprise a trim ledge 1152 positioned around a rim of the seal mold cavity 1151. The trim ledge 1152 may be substantially similar in structure and function to the trim ledge 1052 of the mold 1050 and, therefore not described in further detail herein. A sealing polymeric layer (e.g., a foaming urethane or polyurea) may be deposited (e.g., spray coated) in the seal mold cavity 1151 and the first face 1114a and/or second face 1114b of the filter media 1110 may be positioned or embedded therein so as to seal the respective faces 1114a/b of the filter media 1110.

In particular embodiments, one or more markings (e.g., part number, product number, logo, company name, etc.), indicated by the arrow M in FIG. 12, may be embossed or engraved on a base of the mold cavity 1151. The markings may be transferred in the sealing polymeric layer (e.g., spray coated polyurethane) so that the markings appear engraved or embossed on the faces 1114a/b of the filter media 1110 once the faces 1114a/b are embedded in the sealing polymeric layer.

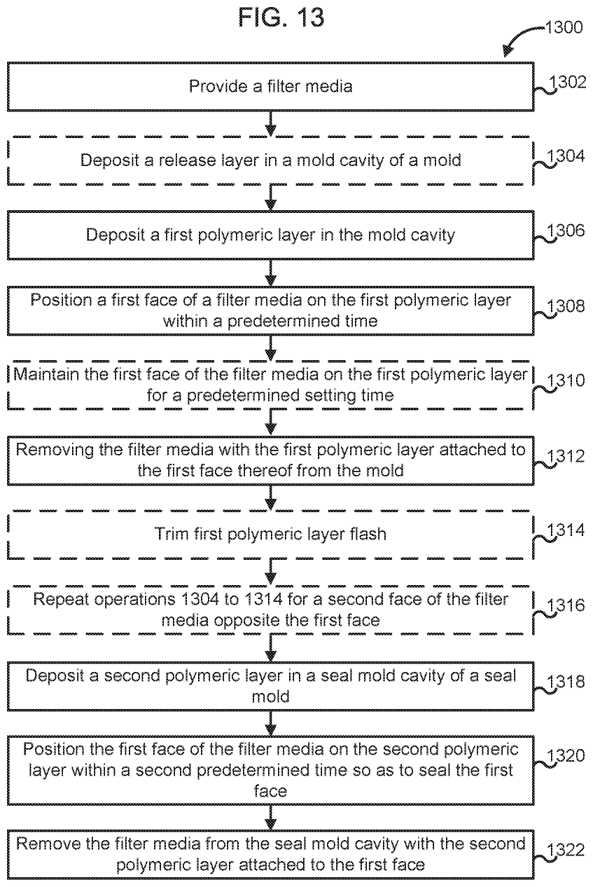

FIG. 13 is a schematic flow diagram of an example method 1300 for forming a filter element (e.g., the filter element 1100 shown in FIG. 11) having at least a portion of a filter media (e.g., the filter media 1110 of FIG. 11) thereof encased in a polymeric layer (e.g., polyurethane and/or polyurea), according to another embodiment.

The method 1300 comprises providing the filter media, at 1302. The filter media comprises a porous material having a predetermined pore size and is configured to filter particulate matter from a fluid flowing therethrough (e.g., air or an air-fuel mixture). The filter media may comprise a V-shaped filter media, for example, the filter media 1110.

In some embodiments, a release layer is deposited in a mold cavity of a mold, at 1304. The mold may include, for example, the mold 1050 or the seal mold 1150. The release layer may be formed from a low surface tension release agent deposited (e.g., sprayed, poured, vapor deposited, etc.) into the mold cavity, and may include any suitable release layer as previously described herein.

A first polymeric layer is deposited into the mold cavity of the mold, at 1306. For example, the polymeric layer may be in fluid form (e.g., dissolved in solvent to form a sprayable liquid) or is spray coated on the surface of the mold cavity (e.g., the mold cavity 1051, 1151 of the mold 1050, 1150 respectively). Any suitable first polymeric material may be used for the first polymeric layer such as, for example, polyurethane, polyurea, polyvinyl alcohol, polytetrafluoroethylene, high density polyethylene, polyvinyl chloride, a thermoset polymer, a reinforced polymer, or a combination thereof. In particular embodiments, the first polymeric layer comprises a polyurethane formulated to set within a predetermined time, for example, within a range of 10-20 seconds. In a specific embodiment, the first polymeric material includes BASF® ElastoCast 555090. The first polymeric material may be dissolved in a solvent (e.g., acetone, methylene chloride, acetates, dimethyl sulfoxide, chloroform, tetrahydrofuran, an organic non-toxic solvent, any other solvent or combination thereof) so as to form a sprayable liquid. In other embodiments, the first polymeric material may be dispensed, for example, poured into the mold cavity (e.g., the mold cavity 1051, 1151).

A first face of the filter media is positioned on the first polymeric layer within a predetermined time, at 1308. For example, the first face 1114a of the filter media 1110 is positioned on the first polymeric layer. Positioning the filter media on the first polymeric layer may cause the first polymeric layer, for example a liquid, a non-Newtonian liquid, a Bingham liquid, or a semi-solid polymeric layer to penetrate folds of the filter media or generally stick to a first face (e.g., the first face 1114a) of the filter media (1110). The predetermined time (e.g., in a range of 10-20 seconds) may be a time period within which the polymeric layer at least partially sets (i.e., reacts or crosslinks). In other embodiments, the first polymeric layer may partially set (e.g., turns from a sprayable liquid to a semi-solid) within the predetermined time so as to facilitate embedding or potting of the first face (e.g., the first face 1114a) of the filter media (e.g., the filter media 1110) therein when the filter media is positioned on the first polymeric layer. In some embodiments, the first face of the filter media may be coated (e.g., spray coated) with a coat of the first polymeric layer before positioning the first face of the filter media on the first polymeric layer deposited in the mold cavity. This may allow better adhesion of the first polymeric layer to the first face of the filter media.

In particular embodiments, the first face of the filter media may be maintained on the first polymeric layer for a predetermined setting time, at 1310. The first polymeric layer may be formulated to set and adhere to the first face of the filter media within the predetermined setting time. For example, the predetermined setting time may include a time period that the first polymeric layer takes to completely set (i.e., all the solvent evaporates and the polymeric layer completely solidifies) from the time point at which the first face of the filter media is positioned on the first polymeric layer. In some embodiments, the predetermined setting time may be in a range of 5 seconds to 30 seconds after the predetermined time (e.g., 25 seconds to 50 seconds after the first polymeric layer is deposited in the mold cavity).

The filter media is removed from the mold cavity with the first polymeric layer attached to the first face thereof, at 1312. Expanding further, removing of the filter media from the mold cavity causes the first polymeric layer to also be removed from the mold cavity along with the filter media (e.g., facilitated by the release agent). In this manner, the first face of the filter media may be wrapped or otherwise encapsulated in the first polymeric layer in a rapid and simple fashion.

In some embodiments, the method 1300 may also include trimming a first polymeric layer flash from the first polymeric layer, at 1314. For example, the first polymeric layer may include first polymeric layer flash extending from ends of the first polymeric layer. The first polymeric layer flash may form during depositing (e.g., spray coating) of the mold into the mold cavity, for example, the first polymeric material may flow over a rim of the mold cavity (e.g., the mold cavity 1051, 1151) so as to form the first polymeric layer flash. In other instances, the first polymeric layer flash may be formed as the first face of the filter media is positioned on the first polymeric layer. For example, the first face (e.g., the first face 1114a) of the filter media (e.g., the filter media 1110) may be pushed into the first polymeric layer, causing a portion of the first polymeric layer to flow around the first face beyond the rim of the mold cavity, and form the first polymeric layer flash. The first polymeric layer flash may not be attached to the filter media, and is trimmed off (e.g., using a knife, a blade, a fixture, or manually removed). In various embodiments, the method 1300 may also include repeating operations 1304 to 1314 of the method 1300 for a second face (e.g., the second face 1114b) of the filter media (e.g., the filter media 1110), at 1316.

The method 1300 also comprises depositing a second polymeric layer in a seal mold cavity of a seal mold, at 1318. For example, a second polymeric layer may be deposited in the seal mold cavity 1151 of the seal mold 1150. In particular embodiments, a release layer may also be deposited in the seal mold cavity before depositing the second polymeric layer therein, as previously described herein.

In particular embodiments, the second polymeric layer may be spray coated in the seal mold cavity (e.g., the seal mold cavity 1151). For example, the second polymeric layer may comprise a second polymeric material formulated to be spray coated in the seal mold cavity (e.g., foaming urethane or polyurea). The second polymeric material may be the same as or different from the first polymeric material. In some embodiments, spray coating the polymeric layer in the seal mold cavity may cause any markings defined on a base of the seal mold cavity (e.g., the markings M defined in the seal mold cavity 1151) to be transferred into the second polymeric layer.

The first face of the filter media is positioned on the second polymeric layer within a second predetermined time so as to seal the first surface, at 1320. For example, the first face 1114a of the filter media 1110 is positioned (e.g., potted or embedded) in the second polymeric layer within the second predetermined time (e.g., in a range of 5 seconds to 30 seconds) so as to attach the second polymeric layer on the first face 1114a. The filter media is removed from the seal mold cavity with the second polymeric layer attached thereto, at 1322. For example, the filter media 1110 may be removed from the seal mold cavity 1151 with the second polymeric layer (e.g., a foaming polyurethane or polyurea layer) attached to the first face 1114a thereof. In this manner, the second polymeric layer may form end caps or otherwise seals on the first face and/or second face of the filter media. Since markings may be embossed or engraved on the second polymeric layer during the seal molding process, external labels may not be used. In various embodiments, a thickness of the second polymeric layer may be less than the first polymeric layer such that the second polymeric layer serves a seal layer, an end cap or a labeling layer.

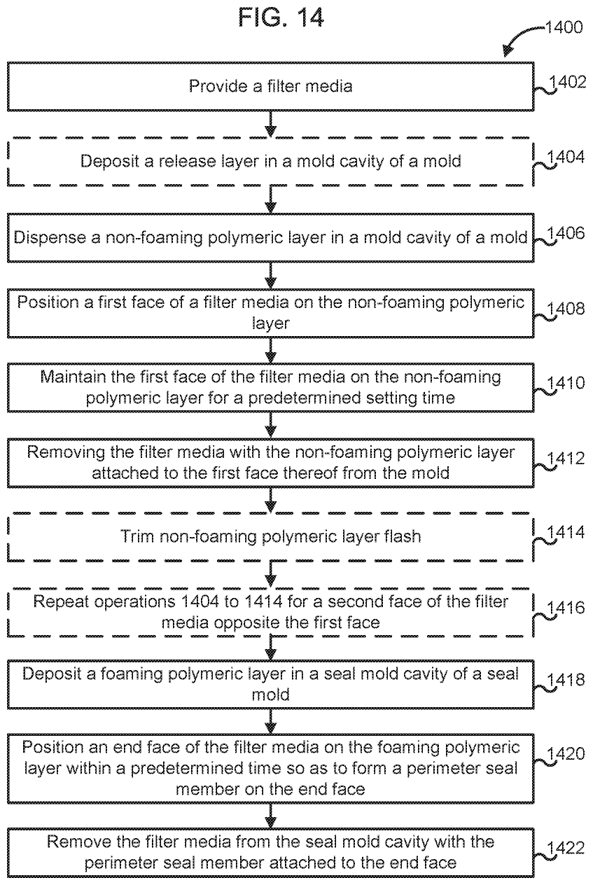

FIG. 14 is a schematic flow diagram of another example method 1400 for forming a filter element (e.g., the filter element 1100 shown in FIG. 11) having at least a portion of a filter media (e.g., the filter media 1110 of FIG. 11) thereof encased in a polymeric layer (e.g., polyurethane and/or polyurea), according to another embodiment.

The method 1400 comprises providing the filter media (e.g., the filter media 1110), at 1402. In some embodiments, a release layer is deposited in a mold cavity of a mold, at 1404. The mold may include, for example, the mold 1050 or the seal mold 1150. The release layer may be formed from a low surface tension release agent deposited (e.g., sprayed, poured, vapor deposited, etc.) into the mold cavity, and may include any suitable release layer, as previously described herein.

A non-foaming polymeric layer is deposited into the mold cavity of the mold, at 1406. The non-foaming polymeric layer may comprise, for example, a non-foaming polyurethane which may be poured (e.g., by a dispensing machine) into the mold cavity. A first face of the filter media is positioned on the non-foaming polymeric layer, at 1408. For example, the first face 1114a of the filter media 1110 is positioned on the non-foaming polymeric layer. Positioning of the first face of the filter media on the non-foaming polymeric layer may cause the non-foaming polymeric layer, for example a liquid, a non-Newtonian liquid, a Bingham liquid, or a semi-solid polymeric layer to penetrate folds of the filter media or generally stick to a first face of the filter media. The first face of the filter media may be maintained on the first polymeric layer for a predetermined setting time, at 1410. The first polymeric layer may be formulated to set and adhere to the first face of the filter media within the predetermined setting time (e.g., in a range of 25-50 seconds). For example, the predetermined setting time may include a time period that the first polymeric layer takes to completely set (i.e., all the solvent evaporates and the polymeric layer completely solidifies) from the time point at which the first face of the filter media is positioned on the first polymeric layer.

The filter media is removed from the mold cavity with the non-foaming polymeric layer attached to the first face thereof, at 1412. Expanding further, removing of the filter media from the mold cavity causes the non-foaming polymeric layer to also be removed from the mold cavity along with the filter media (e.g., facilitated by the release agent). In some embodiments, the method 1400 may also include trimming a first polymeric layer flash from the first polymeric layer, at 1414, for example, as previously described herein. In various embodiments, the method 1400 may also include repeating operations 1404 to 1414 of the method 1400 for a second face (e.g., the second face 1114b) of the filter media (e.g., the filter media 1110), at 1416.

The method 1400 also comprises depositing a foaming polymeric layer in a seal mold cavity of a seal mold, at 1418. The foaming polymeric layer may comprise a foaming polymeric material such as, for example, foaming polyurethane or polyurea. For example, a foaming polymeric layer may be deposited in the seal mold cavity 1151 of the seal mold 1150. In particular embodiments, the foaming polymeric material may be deposited along edges of the seal mold cavity 1151 or in grooves corresponding to a perimeter of an end face (e.g., the end face 1116) of the filter media (e.g., the filter media 1110).

The end face of the filter media is positioned on the foaming polymeric layer within a second predetermined time so as to form a perimeter seal member on the end face, at 1420. For example, the end face 1116 of filter media 1110 may be positioned (e.g., potted or embedded) on the foaming polymeric layer within the second predetermined time (e.g., 5-20 seconds), and the foaming polymeric layer allowed to set. This causes the foaming polymeric layer to adhere (e.g., bond) to edges of the end face 1116 so as to form the perimeter seal member therearound. In other embodiments, the perimeter seal member may be additionally, or alternatively be formed around the first face (e.g., the first face 1114a) of the filter media (e.g., the filter media 1110).

The filter media is removed from the seal mold cavity with the perimeter seal member attached to the end face thereof, at 1422. For example, the filter media 1110 may be removed from the seal mold cavity 1151 of the seal mold 1150 with the perimeter seal member of the foaming polymeric layer attached thereto. The perimeter seal member may serve as a gasket or sealing member configured to fluidly seal the end face and/or the first faces of the filter media when the filter media (e.g., the filter media 1110) is positioned in a filter housing.

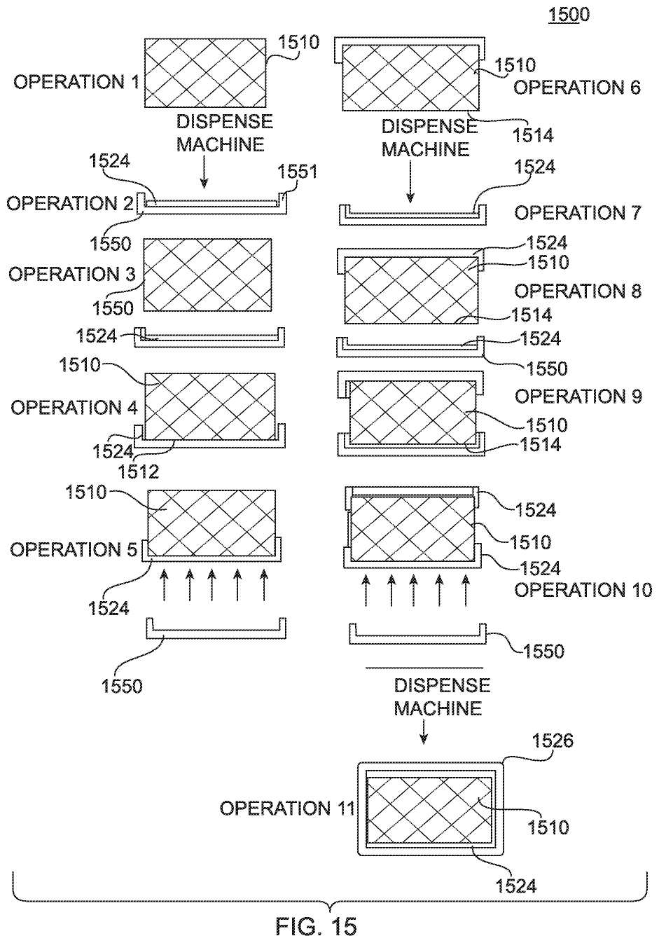

FIG. 15 is a schematic illustration of a process 1500 illustrating various operations of the method 1400 for forming a filter element (e.g., the filter element 1100) having at least a portion of a filter media 1510 (e.g., substantially similar to the filter media 1110) thereof encased in a non-foaming polymeric layer, and a perimeter seal member formed from a foaming polymeric layer positioned on an end face thereof.

The process 1500 comprises providing the filter media 1510, at operation 1. At operation 2, a non-foaming polymeric layer 1524 is dispensed (e.g., poured) into a mold cavity 1551 of a mold 1550 via a dispense machine. The mold 1550 may be substantially similar to the seal mold 1150 or the mold 1050. At operation 3, a first face 1512 of the filter media 1510 is positioned on the non-foaming polymeric layer 1524. Positioning of the first face 1512 of the filter media 1510 on the non-foaming polymeric layer 1524 may cause the non-foaming polymeric layer 1524 (e.g., a non-foaming polyurethane) to penetrate folds of the filter media 1510 or generally stick to the first face 1512 of the filter media 1510.

The first face 1512 of the filter media 1510 is maintained on the non-foaming polymeric layer 1524 for a predetermined setting time, at operation 4. For example, the non-foaming polymeric layer 1524 may be formulated to set and adhere to the first face 1512 of the filter media 1510 within the predetermined setting time (e.g. 5-50 seconds). At operation 5, the filter media 1510 is removed from the mold cavity 1551 with the non-foaming polymeric layer 1524 attached to the first face 1512 thereof.

At operation 6, the filter media 1510 is indexed or rotated 180 degrees so as to position a second face 1514 of the filter media 1510 opposite the first face 1512 towards the mold cavity 1551. At operation 7, the non-foaming polymeric layer 1524 is again dispensed (e.g., poured) into the mold cavity 1551 of the mold 1550 via the dispensing machine. At operation 8, the second face 1514 of the filter media 1510 is positioned on the non-foaming polymeric layer 1524 so as to cause the non-foaming polymeric layer (e.g., a non-foaming polyurethane) to stick or adhere to the second face 1514 of the filter media 1510.

At operation 9, the second face 1514 of the filter media 1510 is maintained on the non-foaming polymeric layer 1524 for the predetermined setting time (e.g. 5-50 seconds). At operation 10, the filter media 1510 is removed from the mold cavity 1551 with the non-foaming polymeric layer 1524 attached to the second face 1514 thereof.

At operation 11, a perimeter seal member 1526 is positioned around an end face of the filter media 1510. For example, a foaming polymeric layer (e.g., a foaming urethane or polyurea) may be deposited in a seal mold cavity (e.g., the seal mold cavity 1151) of a seal mold (e.g., the seal mold 1150), as previously described herein. The end face of the filter media 1510 may be positioned (e.g., potted or embedded) on the foaming polymeric layer within a predetermined time so as to form a perimeter seal member 1526 on the end face. In other embodiments, the perimeter seal member 1526 may be additionally, or alternatively be formed around the first face 1512 and/or the second face 1514 of the filter media 1510. The filter media 1510 may be removed from the seal mold cavity with the perimeter seal member 1526 attached to the end face thereof.

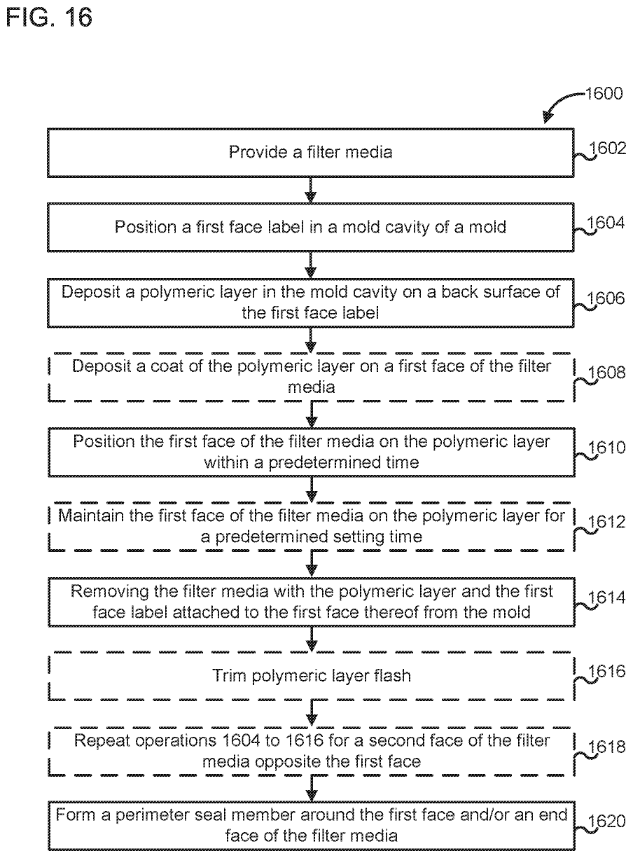

FIG. 16 is a schematic flow diagram of a method 1600 for forming a filter element (e.g., the filter element 1100 shown in FIG. 11) having at least a portion of a filter media (e.g., the filter media 1110 of FIG. 11) thereof encased in a polymeric layer (e.g., polyurethane and/or polyurea), according to yet another embodiment.

The method 1600 comprises providing the filter media (e.g., the filter media 1110), at 1602. At 1604, a first face label is positioned in a mold cavity of a mold (e.g., the mold 1050, 1150, 1550). The first face label may comprise, for example, a paper or cardboard piece or any other suitable label having markings (e.g., product name, product number, company name, company logo, etc.) printed on a front surface thereof. The first face label is positioned in the mold cavity such that the front surface of the first face label is positioned on a base of the mold cavity.

At 1606, a polymeric layer is deposited into the mold cavity on a back surface of the first face label. The polymeric layer may comprise, for example, a non-foaming polyurethane which may be poured (e.g., by a dispensing machine) into the mold cavity, a foaming polymeric layer (e.g., a foaming polyurethane or polyurea), a spray coated polymeric layer or any other suitable polymeric layer. In some embodiments, the polymeric layer may also be coated on a first face of the filter media, at 1608. The coat of the polymeric layer may facilitate adhesion of the polymeric layer to the first face (e.g., the first face 1114a) of the filter media (e.g., the filter media 1110).

At 1610, the first face (e.g., the first face 1114a) of the filter media (e.g., the filter media 1110) is positioned on the polymeric layer. Positioning of the first face of the filter media on the polymeric layer may cause the polymeric layer to penetrate folds of the filter media or generally stick to the first face of the filter media (e.g., facilitated by the coat of the polymeric layer already present on the first face of the filter media).

At 1612, the first face of the filter media may be maintained on the first polymeric layer for a predetermined setting time (e.g., 5-50 seconds), for example, to allow the polymeric layer to completely set. At 1614, the filter media is removed from the mold cavity with the polymeric layer and the first face label attached to the first face thereof. In this manner, the first face label may be attached to the first face of the filter media during the polymeric layer molding process.

In some embodiments, the method 1600 may also include trimming a first polymeric layer flash from the first polymeric layer, at 1616, for example, as previously described herein. In still other operations, the operations 1604 to 1616 of the method 1600 may be repeated for a second face (e.g., the second face 1114b) of the filter media (e.g., the filter media 1110), at 1618. At 1620, a perimeter seal member is formed around the first face (e.g., the first face 1114a) and/or an end face (e.g., the end face 1116) of the filter media (e.g., the filter media 1110), for example, using any of the processes previously described herein with respect to the method 1400 or the process 1500.

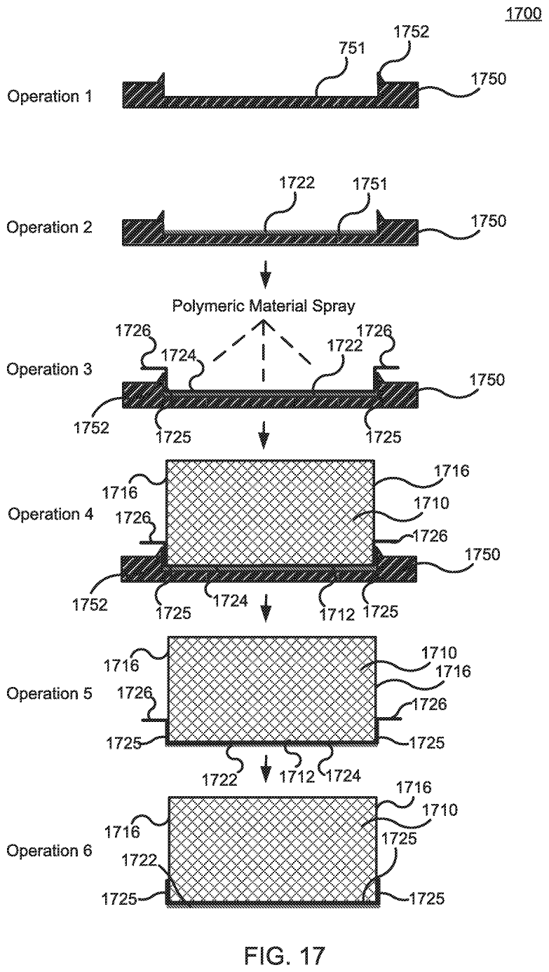

FIG. 17 is a schematic illustration of a process 1700 illustrating various operations of the method 1600. At operation 1, a mold 1750 defining a mold cavity 1751 is provided. A trim ledge 1852 is positioned on a rim of the mold cavity 1751. The mold 1750 may be substantially similar to the mold 1050 or the seal mold 1150 and, therefore not described in further detail herein.

At operation 2, a first face label 1722 is positioned in the mold cavity 1751 of the mold 1750. The first face label 1722 may comprise, for example, a paper or cardboard piece or any other suitable label having markings (e.g., product name, product number, company name, company logo, etc.) printed on a front surface thereof. The first face label 1722 is positioned in the mold cavity 1751 such that the front surface thereof is positioned on a base of the mold cavity 1751.

At operation 3, a polymeric layer 1724 is deposited into the mold cavity 1751 on a back surface of the first face label 1722. The polymeric layer 1724 may comprise, for example, a non-foaming polyurethane which may be poured (e.g., by a dispensing machine) into the mold cavity 1751, a foaming polymeric layer (e.g., a foaming polyurethane or polyurea), a spray coated polymeric layer or any other suitable polymeric layer. The polymeric layer 1724 may adhere or bond to the back surface of the first face label 1722.

At operation 4, a first face 1712 of a filter media 1710 (e.g., a V-shaped filter media such as the filter media 1110) is positioned on the polymeric layer 1724. Positioning of the first face 1712 of the filter media 1710 on the polymeric layer 1724 may cause the polymeric layer 1724 to penetrate folds of the filter media 1710 or generally stick to the first face 1712 of the filter media 1710. A polymeric layer portion 1725 may contact and adhere to a corresponding side face 1716 of the filter media 1710. Moreover, polymeric layer flash 1726 may extend from the ends of the polymeric layer portion 1725.

At operation 5, the filter media 1710 is removed from the mold cavity 1751 with the polymeric layer 1724 attached to the first face 1712 thereof. Removing of the filter media 1710 from the mold cavity 1751 causes the polymeric layer 1724 to be also removed from the mold cavity 1751 along with the filter media 1710. In this manner, the first face 1712 of the filter media 1710 may be wrapped or otherwise encapsulated in the polymeric layer 1724, along with the first face label 1722 attached thereto. At operation 6, the polymeric layer flash 1726 is trimmed (e.g., using a knife, a blade or a fixture, or manually stripped off).

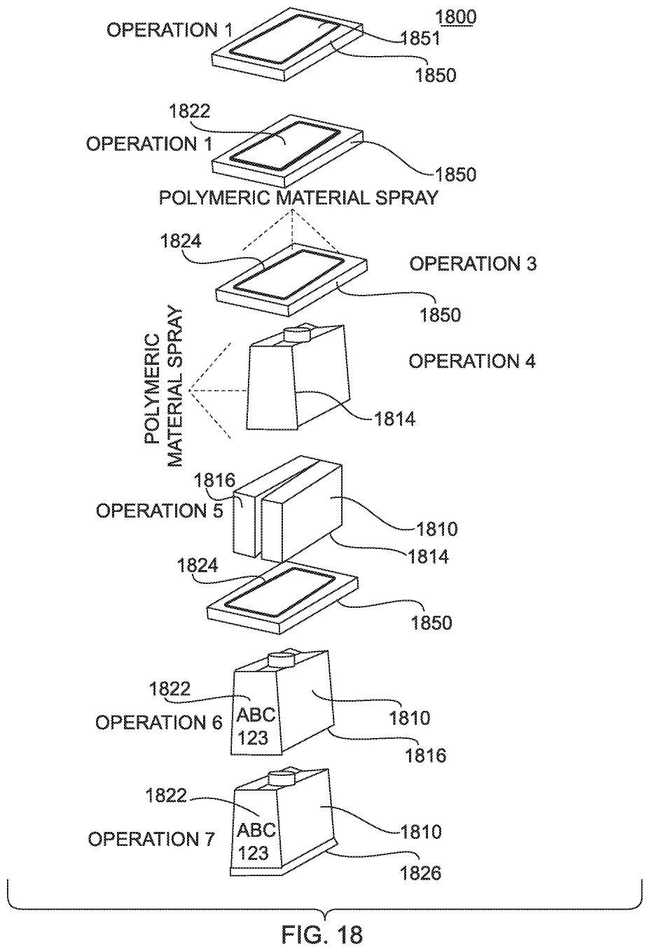

FIG. 18 is a schematic illustration of another process 1800 for embedding a first face 1812 and/or a second face 1814 of a filter media 1810 (e.g., a V-shaped filter media such as the filter media 1110) in a polymeric material with a first face label attached thereto, and forming a perimeter seal member around an end face 1816 of the filter media 1810, according to a particular embodiment.

At operation 1, a mold 1850 defining a mold cavity 1851 is provided. The mold 1850 may be substantially similar to the seal mold 1150. At operation 2, a first face label 1822 is positioned in the mold cavity 1851 of the mold 1850. The first face label 1822 may comprise, for example, a paper or cardboard piece or any other suitable label having markings (e.g., product name, product number, company name, company logo, etc.) printed on a front surface thereof. The first face label 1822 is positioned in the mold cavity 1851 such that the front surface of the first face label 1822 is positioned on a base of the mold cavity 1851.

At operation 3, a polymeric layer 1824 is deposited into the mold cavity 1851 on a back surface of the first face label 1822. The polymeric layer 1824 may comprise, for example, a non-foaming polyurethane which may be poured (e.g., by a dispensing machine) into the mold cavity 1851, a foaming polymeric layer (e.g., a foaming polyurethane or polyurea), a spray coated polymeric layer or any other suitable polymeric layer. The polymeric layer 1824 may adhere or bond to the back surface of the first face label 1822.

At operation 4, a coat of the polymeric material is spray coated on the first face 1812 of the filter media 1810. The coated polymeric material may penetrate folds of the filter media 1810 or generally stick to the first face 1812 of the filter media 1810. At operation 5, the first face 1812 of a filter media 1810 is positioned on the polymeric layer 1824. Positioning of the first face 1812 of the filter media 1810 on the polymeric layer 1824 may cause the polymeric layer coated on the first face 1812 of the filter media 1810 to adhere or otherwise bond to the polymeric layer 1824.

At operation 6, the filter media 1810 is removed from the mold cavity 1851 with the polymeric layer 1824 and the first face label 1822 attached to the first face 1812 of the filter media 1810. At operation 7, a perimeter seal member 1826 comprising a second polymeric material (e.g., a foaming polyurethane or polyurea perimeter seal member) is formed around an end face 1816 of the filter media 1810 (e.g., bonded to edges of the end face 1816 of the filter media 1810). In various embodiments, the perimeter seal member 1826 may be formed using a molding process (e.g., molded in the seal mold 1150), as previously described herein.

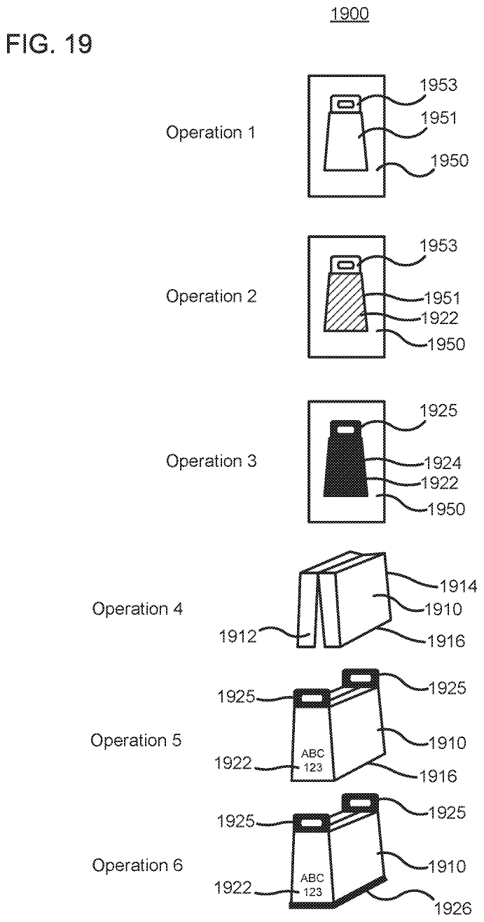

In some embodiments, a mold may be configured to have a mold cavity at least a portion of which is structured to mold a handle in polymeric layer deposited therein. For example, FIG. 19 is a schematic illustration of yet another process 1900 for embedding a first face 1912 and/or a second face 1914 of a filter media 1910 (e.g., a V-shaped filter media such as the filter media 1110) in a polymeric material with a first face label 1922 attached thereto such that a polymeric layer second portion 1925 forms handles during the molding process, and forming a perimeter seal member 1926 around an end face 1916 of the filter media 1910, according to a particular embodiment.

At operation 1, a mold 1950 defining a mold cavity first portion 1951 and a mold cavity second portion 1953 is provided. The mold cavity first portion 1951 is sized and shaped to receive the first face label 1922. The mold cavity second portion 1953 abuts the mold cavity first portion 1951 and is shaped in the form of a handle so as to mold a handle of the filter element in a polymeric layer, as described herein.

At operation 2, a first face label 1922 is positioned in the mold cavity first portion 1951 of the mold 1950. The first face label 1922 may comprise, for example, a paper or cardboard piece or any other suitable label having markings (e.g., product name, product number, company name, company logo, etc.) printed on a front surface thereof. The first face label 1922 is positioned in the mold cavity first portion 1951 such that the front surface of the first face label 1922 is positioned on a base of the mold cavity first portion 1951.

At operation 3, a polymeric layer is deposited in the seal mold 1950 such that a polymeric layer first portion 1924 is deposited into the mold cavity first portion 1951 on a back surface of the first face label 1922, and a polymeric layer second portion 1925 is deposited in the mold cavity second portion 1953. The mold cavity second portion 1952 may also be fluidly coupled to the mold cavity first portion 1951 so as to allow the polymeric layer first portion 1924 to contact the polymeric layer second portion 1925. The polymeric layer may comprise, for example, a non-foaming polyurethane which may be poured (e.g., by a dispensing machine) into the mold cavity first portion 1951 and the mold cavity second portion 1953, a foaming polymeric layer (e.g., a foaming polyurethane or polyurea), a spray coated polymeric layer or any other suitable polymeric layer. The polymeric layer first portion 1924 may adhere or bond to the back surface of the first face label 1922. Furthermore, the polymeric layer second portion 1925 conforms to the shape of the mold cavity second portion 1953 so as to be molded to have a handle shape.

At operation 4, the filter media 1910 is provided. In some embodiments, a coat of the polymeric material may be spray coated on the first face 1912 of the filter media 1910. The coated polymeric material may penetrate folds of the filter media 1910 or generally stick to the first face 1912 of the filter media 1910.

At operation 5, the first face 1912 of the filter media 1910 is positioned on the polymeric layer first portion 1924 in the mold cavity first portion 1951. Positioning of the first face 1912 of the filter media 1910 on the polymeric layer first portion 1924 may cause the first face 1912 of the filter media 1910 to adhere or otherwise bond to the polymeric layer first portion 1924. The filter media 1910 is removed from the mold cavity first portion 1951 with the polymeric layer first portion 1924 and the first face label 1922 attached to the first face 1912 of the filter media 1910. Moreover, the polymeric layer second portion 1925 extends axially from the polymeric layer first portion 1924, opposite the end face 1916 of the filter media 1910 so as to define a polymeric layer handle extending from the first face 1912 of the filter media 1950. Operation 5 may be repeated for a second face 1914 opposite the first face 1912 of the filter media 1910 as to deposit a second face label on the second face 1914 as well form a polymeric layer handle extending from the second face 1914, as shown in FIG. 19.

At operation 7, a perimeter seal member 1926 comprising a second polymeric material (e.g., a foaming polyurethane or polyurea perimeter seal member) is formed around the end face 1916 of the filter media 1910 (e.g., bonded to edges of the end face 1916 of the filter media 1910). In various embodiments, the perimeter seal member 1926 may be formed using a molding process (e.g., molded in the seal mold 1150), as previously described herein.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of forming a filter element having at least a portion of a filter media thereof encased in a polymeric layer, the method comprising:
providing the filter media;
providing a base layer;
depositing the polymeric layer on the base layer so as to form a wrapping layer;
positioning a face of the filter media on the polymeric layer within a predetermined time; and
wrapping the wrapping layer around at least the portion of the filter media.

2. The method of claim 1, wherein the polymeric layer comprises polyurethane.

3. The method of claim 1, further comprising:
forming notches on the polymeric layer at locations thereof proximate to edges of the face of the filter media; and
folding wrapping layer ends of the wrapping layer extending beyond the face of the filter media about the notches towards the filter media, such that the wrapping layer ends contact a corresponding side face of the filter media.

4. The method of claim 3, wherein the method further comprises:
providing a second base layer;
depositing a second polymeric layer on the second base layer so as to form a second wrapping layer;
positioning a second face of the filter media on the second polymeric layer within a second predetermined time, the second face opposite the first face;
forming notches on the second polymeric layer at locations thereof proximate to edges of the second face of the filter media; and
folding second wrapping layer ends of the second wrapping layer extending beyond the second face of the filter media about the notches towards the filter media, such that the second wrapping layer ends contact the corresponding side face of the filter media.

5. A method of forming a filter element having at least a portion of a filter media thereof encased in a polymeric layer, the method comprising:
providing a filter media;
spray depositing a polymeric layer in a mold cavity of a mold;
positioning a first face of the filter media on the polymeric layer within a predetermined time; and
removing the filter media with the polymeric layer attached to the first face thereof from the mold cavity, the removing causing the polymeric layer to be removed from the mold cavity along with the filter media.

6. The method of claim 5, further comprising:
maintaining the first face of the filter media on the polymeric layer for a predetermined setting time, the polymeric layer formulated to set and adhere to the first face of the filter media within the predetermined setting time.

7. The method of claim 5, further comprising:
depositing a release layer in the mold cavity before depositing the polymeric layer therein.

8. The method of claim 5, wherein the polymeric layer includes polymeric layer flash extending from ends of the polymeric layer, the polymeric layer flash not attached to the filter media, and wherein the method further comprises:
trimming the polymeric layer flash.

9. The method of claim 8, wherein the mold further comprises a trim ledge extending axially from a rim of the mold cavity, the trim ledge structured to reduce a thickness of the polymeric layer flash extending outside of the mold cavity.

10. The method of claim 9, wherein an outer surface of the trim ledge is inclined at an angle with respect to a top surface of the mold such that the trim ledge defines a sharp edge at an end thereof.

11. A method of forming a filter element having at least a portion of a filter media thereof encased in a polymeric layer, the method comprising:
providing a filter media;
depositing a first polymeric layer in a mold cavity of a mold;
positioning a first face of the filter media on the first polymeric layer within a predetermined time;
removing the filter media with the first polymeric layer attached to the first face of the filter media from the mold cavity, the removing causing the first polymeric layer to be removed from the mold cavity along with the filter media;
depositing a second polymeric layer in a seal mold cavity of a seal mold;
positioning the first face of the filter media on the second polymeric layer within a second predetermined time so as to seal the first face; and
removing the filter media from the seal mold cavity with the second polymeric layer attached to the first face.

12. The method of claim 11, wherein the filter media comprises a V-shaped filter media.

13. The method of claim 11, wherein the first polymeric layer comprises polyurethane and the second polymeric layer comprises polyurea.

14. The method of claim 11, further comprising:
coating the first face of the filter media with a coat of the polymeric layer before positioning the first face of the filter media on the first polymeric layer disposed in the mold cavity.

15. The method of claim 11, further comprising:
forming a perimeter seal member around at least one of a first face and an end face of the filter media.

16. A method of forming a filter element having at least a portion of a filter media thereof encased in a polymeric layer, the method comprising:
providing a filter media;
positioning a first face label in a mold cavity of a mold such that a front surface of the first face label is positioned on a base of the mold cavity;
depositing a polymeric layer in the mold cavity on a back surface of the first face label;
positioning a first face of the filter media on the polymeric layer within a predetermined time; and
removing the filter media from the mold cavity with the polymeric layer attached to the first face of the filter media and the back surface of the first face label attached to the polymeric layer,
wherein the removing of the filter media from the mold cavity causes the first polymeric layer and the first face label to be removed from the mold cavity along with the filter media.

17. The method of claim 16, wherein the filter media comprises a V-shaped filter media.

18. The method of claim 16, wherein the first polymeric layer comprises polyurethane and the second polymeric layer comprises polyurea.

19. The method of claim 16, further comprising:
coating the first face of the filter media with a coat of the polymeric layer before positioning the first face of the filter media on the first polymeric layer disposed in the mold cavity.

20. The method of claim 16, further comprising:
forming a perimeter seal member around an end face of the filter media.

21. A method of forming a filter element having at least a portion of a filter media thereof encased in a polymeric layer, the method comprising:
providing a filter media;
positioning a first face label in a mold cavity first portion of a mold such that a front surface of the first face label is positioned on a base of the mold cavity first portion, the mold cavity first portion having a size and shape corresponding to a size and shape of the first face label;
depositing a polymeric layer first portion in the mold cavity first portion on a back surface of the first face label;
depositing a polymeric layer second portion in a mold cavity second portion of the mold, the mold cavity second portion abutting the mold cavity first portion and being shaped so as to define a handle;
positioning a first face of the filter media on the polymeric layer first portion in the mold cavity first portion within a predetermined time; and
removing the filter media from the mold cavity first portion with the polymeric layer first portion attached to the first face of the filter media and the back surface of the first face label attached to the polymeric layer first portion, and the polymeric layer second portion attached the polymeric layer first portion,
wherein the removing of the filter media from the mold cavity first portion causes the polymeric layer first portion, the first face label and the polymeric layer second portion to be removed from the mold cavity first portion and the mold cavity second portion, respectively along with the filter media, the polymeric layer second portion extending axially from an edge of the polymeric layer first portion so as to define a handle of the filter element.

22. The method of claim 21, further comprising:
forming a perimeter seal member around an end face of the filter media.
